(19) United States
(12) Patent Application Publication
(10) Pub. No.: US 2025/0260629 A1
(43) Pub. Date: Aug. 14, 2025

(54) MANAGING INTERACTIONS BETWEEN O-CLOUD RESOURCES MANAGEMENT AND ORCHESTRATION AND RADIO ACCESS NETWORK ORCHESTRATION ADMINISTRATION MAINTENANCE FUNCTIONS

(71) Applicants: RAKUTEN SYMPHONY, INC., Tokyo (JP); RAKUTEN MOBILE, INC., Tokyo (JP)

(72) Inventors: Pankaj Tanaji SHETE, Tokyo (JP); Manmeet Singh BHANGU, Andaman and Nicobar Islands (IN)

(73) Assignees: RAKUTEN SYMPHONY, INC., Tokyo (JP); RAKUTEN MOBILE, INC., Tokyo (JP)

(21) Appl. No.: 18/689,655

(22) PCT Filed: Dec. 11, 2023
(86) PCT No.: PCT/US2023/083290

§ 371 Date: Oct. 17, 2024

(30) Foreign Application Priority Data
Apr. 14, 2023 (IN) 202341027672

(51) Int. Cl. H04L 41/342; H04L 41/0895; H04L 41/122

(52) U.S. Cl. CPC H04L 41/342; H04L 41/0895; H04L 41/122

(57) ABSTRACT

Provided are a method, system, and device for managing interactions between an O-Cloud Resources Management and Orchestration (ORMO) Service Management Orchestration Function (SMOF) and a Radio Access Network Operations Administration Maintenance (RANOAM) function. The method may include receiving, by the ORMO, a service related to an SMOF from a Service Management and Exposure (SME); sending, by the ORMO, a request to the SMOF to drain traffic of at least one network function (NF); and sending, by the ORMO, a request to a Topology Exposure and Inventory Management (TE/IV) to update an inventory.

### FIELD

Systems and methods consistent with example embodiments of the present disclosure relate to managing interactions between open radio access network (O-RAN) cloud (O-Cloud) resources management and orchestration (ORMO) and radio access network orchestration administration maintenance (RAN OAM) functions.

### BACKGROUND

A radio access network (RAN) is an important component in a telecommunications system, as it connects end-user devices (or user equipment) to other parts of the network. The RAN includes a combination of various network elements (NEs) that connect the end-user devices to a core network. Traditionally, hardware and/or software of a particular RAN is vendor specific.

Open RAN (O-RAN) technology has emerged to enable multiple vendors to provide hardware and/or software to a telecommunications system. To this end, O-RAN disaggregates the RAN functions into a centralized unit (CU), a distributed unit (DU), and a radio unit (RU). The CU is a logical Node for hosting Radio Resource Control (RRC), Service Data Adaptation Protocol (SDAP), and/or Packet Data Convergence Protocol (PDCP) sublayers of the RAN. The DU is a logical Node hosting Radio Link Control (RLC), Media Access Control (MAC), and Physical (PHY) sublayers of the RAN. The RU is a physical Node that converts radio signals from antennas to digital signals that can be transmitted over the FrontHaul to a DU. Because these entities have open protocols and interfaces between them, they can be developed by different vendors.

FIG. 1 illustrates a related art O-RAN architecture. Referring to FIG. 1, RAN functions in the O-RAN architecture are controlled and optimized by a RIC. The RIC is a software-defined component that implements modular applications to facilitate the multivendor operability required in the O-RAN system, as well as to automate and optimize RAN operations. The RIC is divided into two types: a non-real-time RIC (Non-RT RIC) and a near-real-time RIC (Near-RT RIC).

The Non-RT RIC is the control point of a non-real-time control loop and operates on a timescale greater than 1 second within the Service Management and Orchestration (SMO) framework. Its functionalities are implemented through modular applications called rApps (rApp 1, . . . , rApp N), and include: providing policy based guidance and enrichment across the A1 interface, which is the interface that enables communication between the Non-RT RIC and the Near-RT RIC; performing data analytics; Artificial Intelligence/Machine Learning (AI/ML) training and inference for RAN optimization; and/or recommending configuration management actions over the O1 interface, which is the interface that connects the SMO to RAN managed elements (e.g., Near-RT RIC, O-RAN centralized Unit (O-CU), O-RAN Distributed Unit (O-DU), etc.).

The Near-RT RIC operates on a timescale between 10 milliseconds and 1 second and connects to the O-DU, O-CU (disaggregated into the O-CU control plane (O-CU-CP) and the O-CU user plane (O-CU-UP)), and an open evolved NodeB (O-eNB) via the E2 interface. The Near-RT RIC uses the E2 interface to control the underlying RAN elements (E2 Nodes/network functions (NFs)) over a near-real-time control loop. The Near-RT RIC monitors, suspends/stops, overrides, and controls the E2 Nodes (O-CU, O-DU, and O-eNB) via policies. For example, the Near-RT sets policy parameters on activated functions of the E2 Nodes. Further, the Near-RT RIC hosts xApps to implement functions such as quality of service (QOS) optimization, mobility optimization, slicing optimization, interference mitigation, load balancing, security, etc. The two types of RICs work together to optimize the O-RAN. For example, the Non-RT RIC provides, over the AI interface, the policies, data, and AI/ML models enforced and used by the Near-RT RIC for RAN optimization, and the Near-RT returns policy feedback (i.e., how the policy set by the NON-RT RIC works).

The SMO framework, within which the Non-RT RIC is located, manages and orchestrates RAN elements. Specifically, the SMO includes the Federated O-Cloud Orchestration and Management (FOCOM), a Network Function Orchestrator (NFO) that manages Virtual Machines (VM) based Virtual Network Functions (VNF) and container (i.e., instance) based VNF, and the OAM as a part of the SMO that manages and orchestrates what is referred to as the O-RAN Cloud (O-Cloud). The O-Cloud is a collection of physical RAN Nodes that host the RICs, O-CUs, and O-DUs, the supporting software components (e.g., the operating systems and runtime environments), and the SMO itself. In other words, the SMO manages the O-Cloud from within. The O2 interface is the interface between the SMO and the O-Cloud it resides in. Through the O2 interface, the SMO provides Infrastructure Management Services (IMS) and Deployment Management Services (DMS). The O2 interface may also send O2 telemetry data to the SMO, e.g., O-Cloud configuration or any logical function data, energy consumption, health status of Node, etc.

### SUMMARY

In the related art, O-Cloud Resources Management and Orchestration (ORMO) (which may consist of both the NFO and FOCOM described above) may need to interact with other SMO functions (SMOF's) such as RAN Operations Administration Maintenance (RAN OAM), Topology Exposure and Inventory Management (TE & IV), and other Non-RT RIC SMOF's.

Network Functions (NF's) are typically orchestrated by NFO related capabilities of the ORMO, and these NF applications are configured through RAN OAM via the O1 interface. As an example, in the case of scaling of the NF, prior to terminating any active NF deployment, NF instance traffic associated with that NF deployment may need to be distributed amongst remaining active NF deployments. Accordingly, the NFO may need to instruct the RAN OAM to drain traffic of an NF deployment which is to be terminated. However, in this scenario, there is a need for the RAN OAM to be able to ascertain that policies are enforced as to how to distribute traffic amongst other NF deployment via interactions with other SMOF's such as the NFO, Non-RT RIC, TE &IV or RAN OAM.

Accordingly, there is a need for being able to seamlessly manage interactions between the ORMO and RAN OAM.

Example embodiments of the present disclosure provide a method and system for managing interactions between an O-Cloud Resources Management and Orchestration (ORMO) Service Management Orchestration Function (SMOF) and a Radio Access Network Operations Administration Maintenance (RANOAM) function. The method may include receiving, by the ORMO, a service related to an SMOF from a Service Management and Exposure (SME); sending, by the ORMO, a request to the SMOF to drain traffic of at least one network function (NF); and sending, by the ORMO, a request to a Topology Exposure and Inventory Management (TE/IV) to update an inventory.

According to embodiments, a method for managing interactions between an O-Cloud Resources Management and Orchestration (ORMO) Service Management Orchestration Function (SMOF) and a Radio Access Network Operations Administration Maintenance (RANOAM) function may be provided. The method may include receiving, by the ORMO, a service related to a Service Orchestration (SO) SMOF from a Service Management and Exposure (SME); sending, by the ORMO, a request to the SO SMOF to terminate and redeploy at least one network function (NF); and sending, by the ORMO, a request to a Topology Exposure and Inventory Management (TE/IV) to update an inventory.

According to embodiments, a method for managing interactions between an O-Cloud Resources Management and Orchestration (ORMO) Service Management Orchestration Function (SMOF) and a Radio Access Network Operations Administration Maintenance (RANOAM) function may be provided. The method may include: receiving, by the ORMO, a service related to a Service Orchestration and Assurance (SOA) SMOF from a Service Management and Exposure (SME); sending, by the ORMO, a request to the SOA SMOF to drain traffic of at least one network function (NF); and sending, by the ORMO, a request to a Topology Exposure and Inventory Management (TE/IV) to update an inventory.

Accordingly, it can be understood that since the ORMO can facilitate interactions with the RANOAM and other SMOF's, seamless interaction between different SMOF's can be achieved in order to facilitate managing NF instances.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates an O-RAN architecture according to the related art;

FIG. 2 illustrates a callflow diagram for an interaction between ORMO and RANOAM SMOF according to an embodiment;

FIG. 3 illustrates a callflow diagram for an interaction between ORMO, RANOAM SMOF, including a SO SMOF according to an embodiment;

FIG. 4 illustrates a callflow diagram for an interaction between ORMO, RANOAM SMOF, including an SOA SMOF according to an embodiment;

FIG. 5 illustrates a diagram of an example environment in which systems and/or methods, described herein, may be implemented;

FIG. 6 illustrates a diagram of example components of a device according to an embodiment;

FIG. 7A-7C illustrates a callflow diagram for an interaction between ORMO and RANOAM SMOF according to an embodiment;

FIG. 8A-8D illustrates a callflow diagram for an interaction between ORMO, RANOAM SMOF, including a SO SMOF according to an embodiment; and

FIG. 9A-9C illustrates a callflow diagram for an interaction between ORMO, RANOAM SMOF, including an SOA SMOF according to an embodiment.

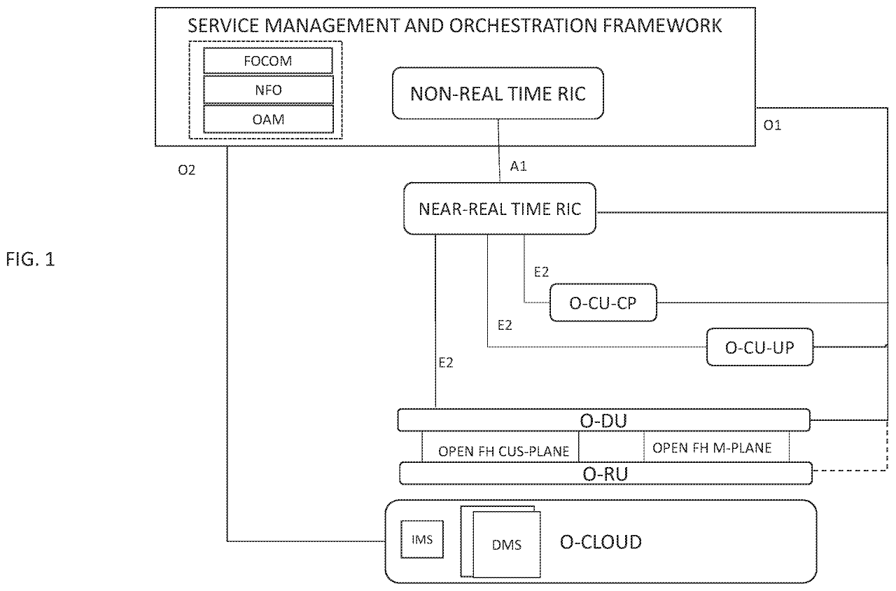

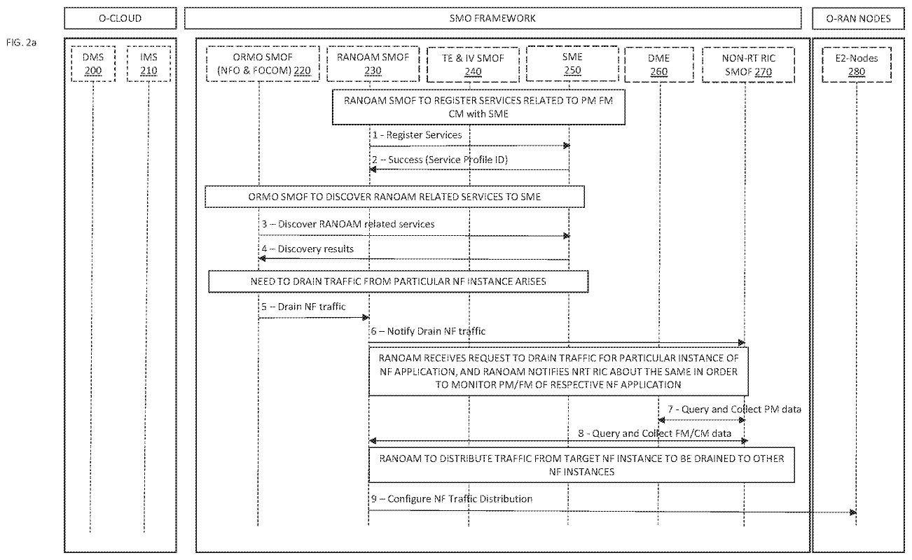

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments are directed to O-Cloud resource optimization, which is a process of utilizing O-Cloud resources in an efficient manner and eliminating waste of O-Cloud resources by selecting, provisioning, and rightsizing the resources within the O-Cloud. In accordance with example embodiments, Network Functions (NFs) within the O-Cloud are orchestrated as VNFs/CNFs. The SMO (NFO, FOCOM) handles the management and orchestration of VNFs/CNFs and underlying O-Cloud infrastructure. The SMO's management, orchestration, and optimization functionalities can be enhanced in accordance with example embodiments by intelligent observability analysis from VNFs/CNFs and O-Cloud.

The Non-RT RIC hosts third-party applications such as rApps in the SMO, which can collect and read various O1 and O2-related observability data and metrics through O1 and O2 related services. These third-party rApps can be leveraged in example embodiments to provide guidance and/or recommendations to the NFO and FOCOM for management, orchestration, and optimization of VNFs/CNFs and underlying O-Cloud infrastructure.

A service orchestrator (SO) and/or service assurance (SA) SMO function (SMOF) may also be provided according to embodiments. The SO SMOF and/or SA SMOF may support orchestrating various procedures which are required for interactions between the RANOAM related functions and providing NFO/FOCOM based services with service assurance. The SO SMOF may use a set of recipes to define steps which are involved in creating a service, and then execute such steps in a sequence in order to ensure that a service is created service. The SO SMOF and/or SA SMOF may accordingly work together to ensure that network services are created and maintained in a consistent and reliable manner. The SO SMOF ensures that services are created correctly, and the SA SMOF ensures that they are performing as expected. This may allow for improved overall quality of service for the network.

It should be appreciated that while NF traffic draining is primarily discussed below as an example of a possible interaction between the ORMO and RANOAM, and that other possible interactions can be achieved by the below embodiments and configurations. For example, configuration or reconfiguring a NF post NF-instantiation by the DMS is a possible interaction between a NFO and RANOAM which could be implemented. Querying operational, administrative, usage states of an NF can also be a possible request sent from a NFO to RANOAM. A notification related to NF state and health could also be sent from the NFO to RANOAM. The NFO can also send a response to actions which are initiated by the RANOAM to RANOAM. RANOAM can also send a notification to the NFO related to NF configuration, traffic draining, and fault reporting.

It should be appreciated that the ORMO (FOCOM/NFO) may support capabilities to receive notifications from RANOAM. The ORMO (FOCOM/NFO) may support capability to configure NF deployment through the RANOAM. The RANOAM may support capabilities to receive notifications from ORMO SMOF. The RANOAM may support capabilities to send notifications to other SMOF's.

Example embodiments of the present disclosure provide a method and system for managing interactions between an O-Cloud Resources Management and Orchestration (ORMO) Service Management Orchestration Function (SMOF) and a Radio Access Network Operations Administration Maintenance (RANOAM) function. It may include receiving, by the ORMO, a service related to an SMOF from a Service Management and Exposure (SME); sending, by the ORMO, a request to the SMOF to drain traffic of at least one network function (NF); and sending, by the ORMO, a request to a Topology Exposure and Inventory Management (TE/IV) to update an inventory. Accordingly, it can be understood that since the ORMO can facilitate interactions with the RANOAM and other SMOF's, seamless interaction between different SMOF's can be achieved in order to facilitate managing NF instances.

Embodimetns of the present disclosure may be directed towards a use case for ORMO & RANOAM SMOF Interactions. Background and goals of the use case may be as follows.

O-Cloud orchestration and managements requires seamless interactions with other SMO functions such as RANOAM, TE & IV, Non-RT RIC SMOF. This use case may focus on interactions with RAN OAM SMOF.

Network functions are orchestrated by NFO related capabilities of ORMO, however those NF application are configured through RAN OAM via O1 interface. In case of Scale In of NF, before terminating any NF deployment i.e. NF instance traffic associated with that NF deployment needs to distribute amongst remaining NF deployment. Here, the NFO needs instruct RAN OAM to drain traffic of NF deployment which is to be terminated. RAN OAM to ascertain policy to distribute traffic among NF deployment through other SMOF such NFO, Non-RT RIC, TE &IV or RAN OAM.

NF traffic draining is example of interaction required between ORMO & RAN OAM, there could be more examples such as, but not necessarily limited to:

NFO→RANOAM: Configuring or Reconfiguring NF post NF instantiation by DMS.

NFO→RANOAM: Querying operational, administrative, usage state of NF.

NFO→RANOAM: Notification related to NF state & health.

NFO→RANOAM: Response to actions initiated by RANOAM.

RANOAM→NFO: Notification related to NF Configuration, Traffic draining, Fault reporting.

Below capabilities may be essential for O-Cloud Orchestration and Management in relation with interaction with other RAN OAM:

FOCOM/NFO to support for capabilities to receive notifications from RANOAM.

FOCOM/NFO to support for capability to configure NF deployment through RAN OAM

RAN OAM to support capabilities to receive notifications from ORMO SMOF.

RAN OAM to support capabilities to send notifications to other SMOF.

Entities/resources which may be involved in the use case are described as follows:

SME SMOF: In a decoupled service-based SMO architecture, the SME can be leveraged as a universal SMO service (SMOS), handling service management and exposure for any SMOS's within the SMO. To support functionality to discover the available services from SMOF and authorization of SMOF to determine which services an SMOF can discover. Support to retrieve the stored service information and performs filtering of available services based on selection criteria that may be provided by the SMOF.

Non-RT RIC SMOF: Support to monitor and evaluate NF PM/FM/CM data via O1 & O2 for NF traffic draining.

ORMO SMOF (NFO & FOCOM): Support registration of capabilities for NFO related services such as with SME. Support receiving and sending necessary notifications for RANOAM SMOF related to life cycle of NF deployment.

O-Cloud (IMS & DMS): Support to receive actions and feedback from ORMO SMOF (NFO & FOCOM) & implement on O-Cloud platform through IMS & DMS

Topology Exposure and Inventory Management (TE & IV) SMOF: Support updating Topology Exposure and Inventory based on request from other SMOF.

RAN OAM SMOF: Supports requests from other SMOF for services such as PM,FM, CM. Notifying other SMOF about mentioned changes in CM requests

Service Orchestrator (SO) and Service assurance (SA) SMOF: Support orchestrating various procedures required for interaction between RAN OAM related function and NFO/FOCOM based services assurance. The SO uses a set of recipes to define the steps involved in creating a service, and it then executes these steps in a sequence to ensure that the service is created correctly. The SO and SA may work together to ensure that network services are created and maintained in a consistent and reliable manner. The SO ensures that the services are created correctly, and the SA ensures that they are performing as expected. This may help to improve the overall quality of service for network customers.

It should be noted that the following requirements may be provided for component elements and SMOF's according to embodiments.

### ORMO Function (ORMOF) Requirements

The ORMOF may support registration of NFO and/or FOCOM related services with SME SMOF. The ORMOF may support traffic draining request for cases such as NF termination towards Service Orchestrator and Assurance. The ORMOF may support invoking O2DMS/O2IMS actions based on SOA or SO recommendations. The ORMOF may support acknowledge notifications related to RAN OAM SMOF

### Non-RT RIC Function (NRTRF) Requirements

The NRTRF may support role of assurance for SOF in cases such as NF traffic draining. The NRTRF may support discovery of SOF or SOAF related services over SMEs

### SOA Function (SOAF) Requirements

The SOAF may support registration of SOA related services over SME. The SOAF may support discovery of SOA related services through SME. The SOAF may support role of services orchestrator to facilitate procedures between various SMOF within SMO. The SOAF may support role of services assurance to enable SLA based procedures within SMO. The SOAF may support ORMOF and RAN OAMF related data collection. TheSOAF may support storing relevant end to end NF application related, O-Cloud Infrastructure related, NF deployment related automation procedures and registering it over SME/DME for discovery purpose.

### SO Function (SOF) Requirements

The SOF may support role of services orchestrator to facilitate procedures between various SMOF within SMO. The SOF may support registration of SO related services over SME. The SOF may support discovery of SO related services through SME. The SOF may support storing relevant end to end NF application related, O-Cloud Infrastructure related, NF deployment related automation procedures and registering it over SME/DME for discovery purpose.

It should be appreciated that the above “requirements” do not necessarily limit the function of the elements thereto, and that the specific function may depend on the specific implementation.

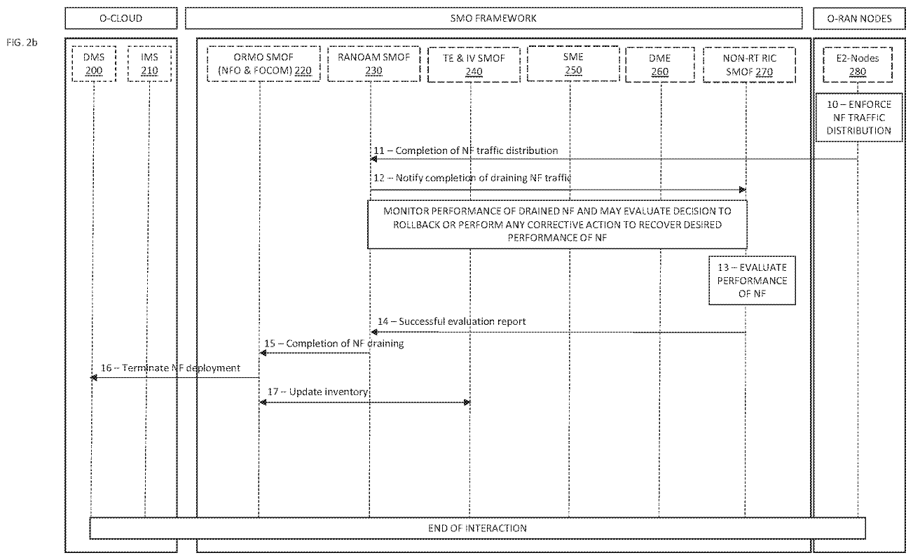

FIG. 2 illustrates a callflow diagram for an interaction between ORMO and RANOAM SMOF according to an embodiment. In particular, the below use-case may be implemented in the case where an rApp and/or a machine learning (ML) model acts as the Service Assurance (SA). That is, the rApp and/or ML model may provide recommendations to perform an action on a particular NF (e.g., recommending to drain a particular NF instance or node). In this particular use-case, no SO is included.

DMS 200 and IMS 210 may operate within the O-Cloud. ORMO SMOF (which may include the NFO and FOCOM) 220, RANOAM SMOF 230, TE & IV SMOF 240, Service Management and Exposure (SME) 250, Data Management and Exposure (DME) 260, Non-RT RIC SMOF 270 may operate within the SMO framework. E2 Nodes 280 may operate within the O-RAN nodes.

DMS 200 and IMS 210 are intended to provide support to receive actions and feedback from the ORMO SMOF 220, and thereby implement actions onto the O-Cloud platform.

ORMO SMOF 220 may include the NFO and FOCOM functionalities. In particular, it may support registration capabilities for NFO related services, such as with SME 250. ORMO SMOF 220 may also support receiving and sending necessary notifications to the RANOAM SMOF 230 which are related to the life-cycle of NF deployment.

RANOAM SMOF 230 supports request from other SMOF's for services related to performance management (PM), fault management (FM), and configuration management (CM). RANOAM SMOF may also be responsible for notifying other SMOF's about mentioned changes in CM requests.

TE & IV SMOF 240 may be responsible for providing support to update a Topology Exposure and Inventory based on requests from other SMOF's.

SME 250 may be leveraged in a decoupled service-based SMO architecture as a universal SMO service (SMOS), by handling service management and exposure for any SMOS within the SMO. SME 250 may also support functionality to discover available services from a particular SMOF and may provide authorization of an SMOF to determine which services an SMOF can discover. SME 250 may also support retrieving stored service information and provide filtering of available services based on selection criteria provided by an SMOF. Accordingly, it may be possible to discover services related to an SMOF using SME 250, according to embodiments.

DME 260 may be used to provide PM data, according to embodiments.

Non-RT RIC SMOF 270 may be responsible for providing support to monitor NF PM/FM/CM data via O1 & O2 interface for the purpose of draining NF traffic.

The embodiment illustrated in FIG. 2 may allow for configuration management (CM) interactions between the ORMO SMOF and RANOAM SMOF. SME 250 may act as the service exposure entity, the Non-RT RIC SMOF 270 may act as an analytical function, ORMO SMOF 220 (which may include the NFO and FOCOM functionality) may act as the O-Cloud Orchestration and Management Function, and the RAN OAMF 230 may act as the CM enforcement entity.

It can be assumed that in the embodiment illustrated in FIG. 2, O2 interface connectivity is established between the SMO and the O-Cloud, that O1 interface connectivity is enabled, and the network is operational.

The embodiment in FIG. 2 may be initiated when the ORMO SMOF 220 initiates a request to RANOAM SMOF 230.

In step 1, the RANOAM SMOF 230 may register its services related to performance management (PM), fault management (FM), and CM with the SME 250.

In step 2, the RANOAM SMOF 230 may receive a message from SME 250 indicating that the services were successfully registered. According to some embodiments, this may include receiving a service profile ID.

In step 3, the ORMO SMOF 220 may discover RANOAM related services with the SME 250.

In step 4, the ORMO SMOF 220 may receive the RANOAM related services from SME 250.

There may arise a need to drain traffic from a particular NF instance (e.g., from a recommendation from an rApp, or due to performance issues).

In step 5, the ORMO SMOF 220 may request RANOAM SMOF 230 to drain the traffic from a particular NF instance.

In step 6, RANOAM SMOF 230 may notify the Non-RT RIC SMOF 270 about the traffic draining request for the particular NF instance. Specifically, this may be so that Non-RT RIC SMOF 270 may monitor PM and FM of the particular NF instance.

In step 7, the Non-RT RIC SMOF 270 may query and collect PM data from DME 260.

In step 8, the Non-RT RIC SMOF 270 may query and collect FM and CM data from RANOAM SMOF 230.

In step 9, the RANOAM SMOF 230 may configure a NF traffic distribution in order to distribute traffic from the particular NF instance to other NF instance(s), and send the configuration to E2 Nodes 280.

In step 10, E2 nodes 280 may enforce the NF traffic distribution configuration received from the RANOAM SMOF 230.

In step 11, E2 nodes 280 may notify RANOAM SMOF 230 that the traffic distribution has been completed.

In step 12, RANAOAM SMOF 230 may notify the Non-RT RIC SMOF 270 that the traffic distribution has been completed (e.g., it may forward the notification).

In step 13, the Non-RT RIC SMOF 270 may evaluate the performance of the drained NF and decide whether to rollback or take any corrective action to recover the desired performance of the NF. This step may optionally be performed.

In step 14, the Non-RT RIC SMOF 270 may send an evaluation report to RANOAM SMOF 230. This may include an indication that rollback should be performed. This step may optionally be performed.

In step 15, RANOAM SMOF 230 may send a notification to ORMO SMOF 220 that NF draining was completed.

In step 16, ORMO SMOF 220 may send a request to DMS 200 to terminate the NF deployment based on receiving the notification from RANOAM SMOF 230 in step 15 above.

In step 17, the ORMO SMOF 220 may update the inventory with TE & IV 240.

The above use-case may end when the O-Cloud becomes non-operational or when the operator disables using the rApp as policy function and/or an ML model for the policy function (e.g., the rApp and/or ML model are no longer being used as an SA).

An example implementation of the steps in FIG. 2 for a use-case of a RAN OAM SMOF to NFO/FOCOM Interaction without SO and rApp as SA may be summarized per the table below. “(M)” may denote a mandatory step and “(O)” may denote an optional one, nevertheless, it should be appreciated that the specific steps used may depend on the specific implementation.

| Use Case | |
|---|---|
| Stage | Evolution/Specification |
| Goal | Enabling CM interactions between ORAMF and RANOAMF |
| Actors and | SME: Service exposure Entity |
| Roles | Non-RT RIC: Analytical Function |
| | ORMO SMOF (Including NFO & FOCOM): O-Cloud |
| | Orchestration and Management function. |
| | RAN OAMF: CM Enforcement Entity |
| Assumptions | O2 interface connectivity is established between SMO and O- |
| | Cloud |
| | O1 interface connectivity is established. |
| | Network is operational. |
| Pre-conditions | ORMOF Initiated O2 procedures as mentioned O-RAN- |
| | WG6.ORCH-USE-CASES in Section 3.2 |
| Begins when | ORMOF initiates request to RAN OAMF. |
| Step 1 (M) | The RANOAM SMOF registers its services related to PM, FM, |
| | and CM with the SME. |
| Step 2 (M) | The ORMO SMOF (NFO/FOCOM) discovers the RANOAM- |
| | related services with the SME. |
| Step 3 (M) | The ORMO SMOF initiates the traffic draining process by |
| | sending a request to the OAM. |
| Step 4 (M) | The OAM notifies the nRT about the traffic draining request. |
| Step 5 (M) | The nRT queries and collects the PM data from the DME. |
| Step 6(M) | The nRT queries and collects the FM/CM data from the OAM. |
| Step 7 (M) | The OAM configures the NF traffic distribution on the E2-Nodes. |
| Step 8 (M) | The E2-Nodes enforce the NF traffic distribution. |
| Step 9 (M) | The E2-Nodes notify the OAM about the completion of the NF |
| | traffic distribution. |
| Step 10 (M) | The OAM notifies the nRT about the completion of the NF traffic |
| | draining. |
| Step 11 (O) | The nRT evaluates the performance of the drained NF and |
| | decides whether to rollback or take any corrective action to |
| | recover the desired performance of the NF. |
| Step 12 (O) | If the nRT decides to rollback, it sends a report to the OAM. |
| Step 13 (M) | The OAM terminates the NF deployment by sending a request to |
| | the DMS. |
| Step 14 (M) | The ORMO SMOF updates the inventory with the TEIV. |
| Ends when | O-Cloud becomes non-operational or when the operator disables |
| | the rApp as policy function or ML model for policy function. |
| Exceptions | TBD |
| Post | End |
| Conditions | |

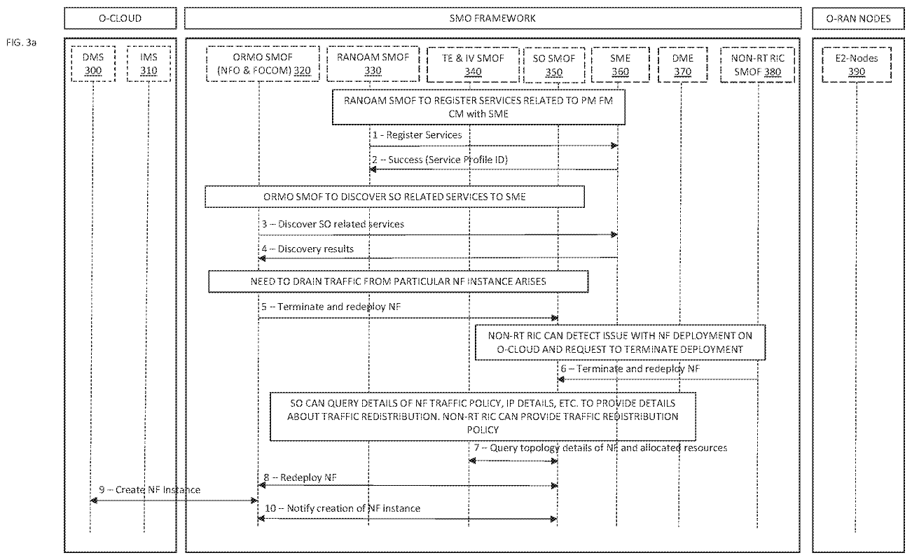

FIG. 3 illustrates a callflow diagram for an interaction between ORMO, RANOAM SMOF, including a SO SMOF according to an embodiment. In particular, the below use-case introduces SO SMOF 350, which may act as the service orchestration entity. The rApp and/or a machine learning (ML) model may act as the Service Assurance (SA).

DMS 300, IMS 310, ORMO SMOF 320, RANOAM SMOF 330, TE & IV SMOF 340, SME 360, DME 370, Non-RT RIC SMOF 380, and E2 Nodes 390 may be similar to DMS 200, IMS 210, ORMO SMOF 220, RANOAM SMOF 230, TE & IV SMOF 240, SME 250, DME 260, Non-RT RIC SMOF 270, E2 Nodes 280 described with reference to FIG. 2 above. Accordingly, redundant descriptions are omitted for the sake of improved readability.

The embodiment illustrated in FIG. 3 may allow for configuration management (CM) interactions between the ORMO SMOF and RANOAM SMOF. SME 360 may act as the service exposure entity, the Non-RT RIC SMOF 380 may act as an analytical function, ORMO SMOF 320 (which may include the NFO and FOCOM functionality) may act as the O-Cloud Orchestration and Management Function, the RAN OAMF 330 may act as the CM enforcement entity, and SO SMOF 350 may act as the service orchestration entity.

The embodiment in FIG. 3 may be initiated when the ORMO SMOF 320 initiates a request to SO SMOF 350.

In step 1, the RANOAM SMOF 330 may register its services related to performance management (PM), fault management (FM), and CM with the SME 350.

In step 2, the RANOAM SMOF 330 may receive a message from SME 360 indicating that the services were successfully registered. According to some embodiments, this may include receiving a service profile ID.

In step 3, the ORMO SMOF 320 may discover SO related services with the SME 360.

In step 4, the ORMO SMOF 320 may receive the SO related services from SME 360.

There may arise a need to drain traffic from a particular NF instance (e.g., from a recommendation from an rApp, or due to performance issues).

In step 5, the ORMO SMOF 320 may request SO SMOF 350 to drain the traffic from a particular NF instance.

As an alternative to step 5, in step 6, the Non-RT RIC SMOF 380 may request SO SMOF 350 to drain the traffic from a particular NF instance. This is based on a case where the Non-RT RIC SMOF 380 can detect an issue with an NF deployment on the O-Cloud and request to terminate deployment.

In step 7, SO SMOF 350 may query and collect topology details of the NF and allocated resources from TE&IV 340.

In step 8, SO SMOF 350 may send a request to ORMO SMOF 320 to redeploy the NF.

In step 9, ORMO SMOF 320 may create an NF instance by sending a request to DMS 300.

In step 10, ORMO SMOF 320 may notify SO SMOF 350 that the instance of the NF was created.

In step 11, SO SMOF 350 may send a request to RANOAM SMOF 330 to drain the NF and redistribute the traffic.

In step 12, RANOAM SMOF 330 may notify the Non-RT RIC SMOF 380 about the traffic draining request for the particular NF instance. Specifically, this may be so that Non-RT RIC SMOF 370 may monitor PM and FM of the particular NF instance.

In step 13, the Non-RT RIC SMOF 380 may query and collect PM data from DME 370.

In step 14, the Non-RT RIC SMOF 380 may query and collect FM and CM data from RANOAM SMOF 330.

In step 15, the RANOAM SMOF 330 may configure a NF traffic distribution in order to distribute traffic from the particular NF instance to other NF instance(s), and send the configuration to E2 Nodes 390.

In step 16, E2 nodes 390 may enforce the NF traffic distribution configuration received from the RANOAM SMOF 330.

In step 17, E2 nodes 390 may notify RANOAM SMOF 330 that the traffic distribution has been completed.

In step 18, RANOAM SMOF 330 may notify SO SMOF 350 that traffic distribution has been completed (e.g., it may forward the notification).

In step 19, RANAOAM SMOF 330 may notify the Non-RT RIC SMOF 380 that the traffic distribution has been completed (e.g., it may forward the notification).

In step 20, the Non-RT RIC SMOF 380 may evaluate the performance of the drained NF and decide whether to rollback or take any corrective action to recover the desired performance of the NF. This step may optionally be performed.

In step 21, the Non-RT RIC SMOF 380 may send an evaluation report to RANOAM SMOF 330. This may indicate that there are no issues with the performance (e.g., it is successful). This step may optionally be performed.

As an alternative to step 21, if there were issues with the performance, in step 22, the Non-RT RIC SMOF 380 may send a failing evaluation report to RANOAM SMOF 330, indicating that rollback or corrective actions should be performed. This step may optionally be performed. The SO SMOF 350 may choose to perform such corrective action based on receiving this evaluation report.

In step 23, SO SMOF 350 may send a request to ORMO SMOF 320 to terminate the NF deployment.

In step 24, ORMO SMOF 320 may send a request to DMS 300 to terminate the NF deployment based on receiving the request from SO SMOF 350 in step 23 above.

In step 25, the ORMO SMOF 320 may update the inventory with TE & IV 340.

In addition or as an alternative to step 25, in step 26, the SO SMOF 350 may update the inventory with TE & IV 340.

The above use-case may end when the O-Cloud becomes non-operational or when the operator disables using the rApp as policy function and/or an ML model for the policy function (e.g., the rApp and/or ML model are no longer being used as an SA).

An example implementation of the steps in FIG. 3 for a use-case of a RAN OAM SMOF to NFO/FOCOM Interaction with SO and rApp as SA may be summarized per the table below. “(M)” may denote a mandatory step and “(O)” may denote an optional one, nevertheless, it should be appreciated that the specific steps used may depend on the specific implementation.

| Use Case | |
|---|---|
| Stage | Evolution/Specification |
| Goal | Enabling CM interactions between ORAMF and RANOAMF |
| Actors and | SME: Service exposure Entity |
| Roles | Non-RT RIC: Analytical Function |
| | ORMO SMOF (Including NFO & FOCOM): O-Cloud Orchestration |
| | and Management function. |
| | RAN OAMF: CM Enforcement Entity |
| | SO SMOF: Service orchestration entity |
| Assumptions | O2 interface connectivity is established between SMO and O-Cloud |
| | O1 interface connectivity is established. |
| | Network is operational. |
| Pre-conditions | ORMOF Initiated O2 procedures as mentioned O-RAN- |
| | WG6.ORCH-USE-CASES in Section 3.2 |
| Begins when | ORMOF initiates request to SO SMOF. |
| Step 1 (M) | The RANOAM SMOF registers its services related to PM, FM, and |
| | CM with the SME. |
| Step 2 (M) | The ORMO SMOF (NFO/FOCOM) discovers the SO related to |
| | services with the SME. |
| Step 3 (M) | The ORMO SMOF or the Non-RT RIC initiates the NF termination |
| | and redeployment process by sending a request to the SO. |
| Step 4 (M) | The SO queries the TEIV for the topology details of the NF and the |
| | allocated resources. |
| Step 5 (M) | The SO redeploys the NF by sending a request to the ORMO. |
| Step 6(M) | The ORMO creates an NF instance by sending a request to the DMS. |
| Step 7 (M) | The ORMO notifies the SO about the creation of the NF instance. |
| Step 8 (M) | The SO notifies the OAM to drain the NF and redistribute the traffic. |
| Step 9 (M) | The OAM notifies the nRT about the NF draining request. |
| Step 10 (M) | The nRT queries and collects the PM data from the DME. |
| Step 11 (O) | The nRT queries and collects the FM/CM data from the OAM. |
| Step 12 (O) | The OAM configures the NF traffic distribution on the E2-Nodes. |
| Step 13 (M) | The E2-Nodes enforce the NF traffic distribution. |
| Step 14 (M) | The E2-Nodes notify the OAM about the completion of the NF traffic |
| | distribution. |
| Step 15 (M) | The OAM notifies the nRT about the completion of the NF draining. |
| Step 16 (M) | The nRT evaluates the performance of the drained NF and decides |
| | whether to rollback or take any corrective action to recover the |
| | desired performance of the NF. |
| Step 17 (M) | If the nRT decides to rollback, it sends a report to the SO. |
| Step 18 (M) | The SO executes the revised policy or recommendation, which may |
| | involve re-draining the NF and redistributing the traffic. |
| Step 19 (M) | The SO terminates the NF deployment by sending a request to the |
| | ORMO. |
| Step 20 (M) | The ORMO terminates the NF deployment by sending a request to |
| | the DMS. |
| Step 21 (M) | The ORMO or the SO updates the inventory with the TEIV. |
| Ends when | O-Cloud becomes non-operational or when the operator disables the |
| | rApp as policy function or ML model for policy function. |
| Exceptions | TBD |
| Post | End |
| Conditions | |

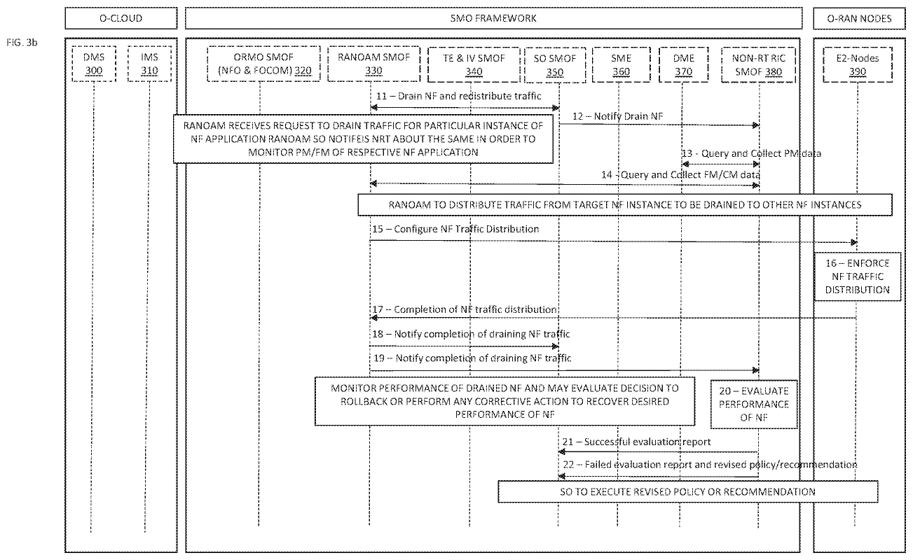

FIG. 4 illustrates a callflow diagram for an interaction between ORMO, RANOAM SMOF, including a Service Orchestration and Assurance (SOA) SMOF according to an embodiment. In particular, the below use-case introduces SOA SMOF 450, which may provide both SO and SA functionality.

DMS 400, IMS 410, ORMO SMOF 420, RANOAM SMOF 430, TE & IV SMOF 440, SME 460, DME 470, Non-RT RIC SMOF 480, and E2 Nodes 490 may be similar to DMS 200, IMS 210, ORMO SMOF 220, RANOAM SMOF 230, TE & IV SMOF 240, SME 250, DME 260, Non-RT RIC SMOF 270, E2 Nodes 280 described with reference to FIG. 2 above. Accordingly, redundant descriptions are omitted for the sake of improved readability.

The embodiment illustrated in FIG. 4 may allow for configuration management (CM) interactions between the ORMO SMOF and RANOAM SMOF. SME 460 may act as the service exposure entity, the Non-RT RIC SMOF 480 may act as an analytical function, ORMO SMOF 420 (which may include the NFO and FOCOM functionality) may act as the O-Cloud Orchestration and Management Function, the RAN OAMF 430 may act as the CM enforcement entity, and SOA SMOF 450 may act as the service orchestration entity.

The embodiment in FIG. 4 may be initiated when the ORMO SMOF 420 initiates a request to SOA SMOF 450.

In step 1, the RANOAM SMOF 430 may register its services related to performance management (PM), fault management (FM), and CM with the SME 450.

In step 2, the RANOAM SMOF 430 may receive a message from SME 460 indicating that the services were successfully registered. According to some embodiments, this may include receiving a service profile ID.

In step 3, the ORMO SMOF 420 may discover SOA related services with the SME 460.

In step 4, the ORMO SMOF 420 may receive the SOA related services from SME 460.

There may arise a need to drain traffic from a particular NF instance (e.g., from a recommendation from an rApp, or due to performance issues). This may be detected by ORMO SMOF 420. In this case, in step 5, the ORMO SMOF 420 may request SOA SMOF 450 to terminate and redeploy a particular NF instance.

As an alternative to step 5, the SOA may detect an issue with the NF deployment based on, for instance, an automation algorithm for SA. Accordingly, SOA SMOF 450 may also request and terminate the NF itself in step 6.

In step 7, SOA SMOF 450 may query and collect topology details of the NF and allocated resources from TE&IV 440.

In step 8, SOA SMOF 450 may send a request to ORMO SMOF 420 to redeploy the NF.

In step 9, SOA SMOF 450 may send a request to RANOAM SMOF 430 to drain the NF and redistribute the traffic.

In step 10, RANOAM SMOF 430 may notify the Non-RT RIC SMOF 480 about the traffic draining request for the particular NF instance. Specifically, this may be so that Non-RT RIC SMOF 470 may monitor PM and FM of the particular NF instance.

In step 11, the Non-RT RIC SMOF 480 may query and collect PM data from DME 470.

In step 12, the Non-RT RIC SMOF 480 may query and collect FM and CM data from RANOAM SMOF 430.

In step 13, the RANOAM SMOF 430 may configure a NF traffic distribution in order to distribute traffic from the particular NF instance to other NF instance(s), and send the configuration to E2 Nodes 490.

In step 14, E2 nodes 490 may enforce the NF traffic distribution configuration received from the RANOAM SMOF 430.

In step 15, E2 nodes 490 may notify RANOAM SMOF 430 that the traffic distribution has been completed.

In step 16, RANOAM SMOF 430 may notify SOA SMOF 450 that traffic distribution has been completed (e.g., it may forward the notification).

In step 17, RANAOAM SMOF 430 may notify the Non-RT RIC SMOF 480 that the traffic distribution has been completed (e.g., it may forward the notification).

In step 18, the Non-RT RIC SMOF 480 may evaluate the performance of the drained NF and decide whether to rollback or take any corrective action to recover the desired performance of the NF. This step may optionally be performed.

In step 19, the Non-RT RIC SMOF 480 may send an evaluation report to SOA SMOF 450. This may indicate that there are no issues with the performance (e.g., it is successful). This step may optionally be performed.

As an alternative to step 19, if there were issues with the performance, in step 20, the Non-RT RIC SMOF 480 may send a failing evaluation report to SOA SMOF 450, indicating that rollback or corrective actions should be performed. This step may optionally be performed. The SOA SMOF 450 may choose to perform such corrective action based on receiving this evaluation report.

In step 21, SOA SMOF 450 may send a request to ORMO SMOF 420 to terminate the NF deployment.

In step 22, ORMO SMOF 420 may send a request to DMS 400 to terminate the NF deployment based on receiving the request from SOA SMOF 450 in step 21 above.

In step 23, the ORMO SMOF 420 may update the inventory with TE & IV 440.

In addition or as an alternative to step 23, in step 24, the SOA SMOF 450 may update the inventory with TE & IV 440.

The above use-case may end when the O-Cloud becomes non-operational or when the operator disables using the rApp as policy function and/or an ML model for the policy function (e.g., the rApp and/or ML model are no longer being used as an SA).

An example implementation of the steps in FIG. 4 for a use-case of a RAN OAM SMOF to NFO/FOCOM Interaction with SOA may be summarized per the table below. “(M)” may denote a mandatory step and “(O)” may denote an optional one, nevertheless, it should be appreciated that the specific steps used may depend on the specific implementation.

| Use Case | |
|---|---|
| Stage | Evolution/Specification |
| Goal | Enabling CM interactions between ORAMF and RANOAMF |
| Actors and | SME: Service exposure Entity |
| Roles | Non-RT RIC: Analytical Function |
| | ORMO SMOF (Including NFO & FOCOM): O-Cloud Orchestration |
| | and Management function. |
| | RAN OAMF: CM Enforcement Entity |
| | SOA SMOF: Service orchestration and assurance entity |
| Assumptions | O2 interface connectivity is established between SMO and O-Cloud |
| | O1 interface connectivity is established. |
| | Network is operational. |
| Pre-conditions | ORMOF Initiated O2 procedures as mentioned O-RAN- |
| | WG6.ORCH-USE-CASES in Section 3.2 |
| Begins when | ORMOF initiates request to SOA SMOF. |
| Step 1 (M) | The RANOAM SMOF registers its services related to PM, FM, and |
| | CM with the SME. |
| Step 2 (M) | The ORMO SMOF (NFO/FOCOM) discovers the SO&A related to |
| | services with the SME. |
| Step 3 (M) | The ORMO SMOF or the SOA SMOF initiates the NF termination |
| | and redeployment process by sending a request to the SOA. |
| Step 4 (M) | The SOA queries the TEIV for the resource details of the NF. |
| Step 5 (M) | The SOA redeploys the NF by sending a request to the ORMO. |
| Step 6(M) | The SOA distributes the traffic by sending a request to the OAM. |
| Step 7 (M) | The OAM notifies the nRT about the NF draining request. |
| Step 8 (M) | The nRT queries and collects the PM data from the DME. |
| Step 9 (M) | The nRT queries and collects the FM/CM data from the OAM. |
| Step 10 (M) | The OAM configures the NF traffic distribution on the E2-Nodes. |
| Step 11 (O) | The E2-Nodes enforce the NF traffic distribution. |
| Step 12 (O) | The E2-Nodes notify the OAM about the completion of the NF traffic |
| | distribution. |
| Step 13 (M) | The OAM notifies the nRT about the completion of the NF draining. |
| Step 14 (M) | The SOA evaluates the performance of the drained NF and decides |
| | whether to rollback or take any corrective action to recover the |
| | desired performance of the NF. |
| Step 15 (M) | If the SOA decides to rollback, it sends a report to itself. |
| Step 16 (M) | The SOA executes the revised policy or recommendation, which may |
| | involve re-draining the NF and redistributing the traffic. |
| Step 17 (M) | The SOA terminates the NF deployment by sending a request to the |
| | ORMO. |
| Step 18 (M) | The ORMO terminates the NF deployment by sending a request to |
| | the DMS. |
| Step 19 (M) | The ORMO or the SOA updates the inventory with the TEIV. |
| Ends when | O-Cloud becomes non-operational or when the operator disables the |
| | rApp as policy function or ML model for policy function. |
| Exceptions | TBD |
| Post | End |
| Conditions | |

Based on the above embodiments, it can be understood that since the ORMO can facilitate interactions with the RANOAM and other SMOF's, seamless interaction between different SMOF's can be achieved in order to facilitate managing NF instances.

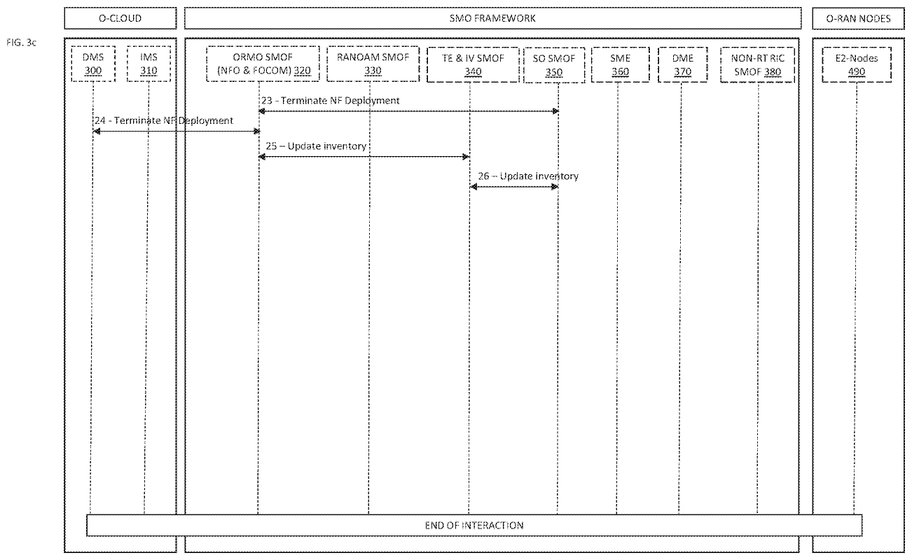

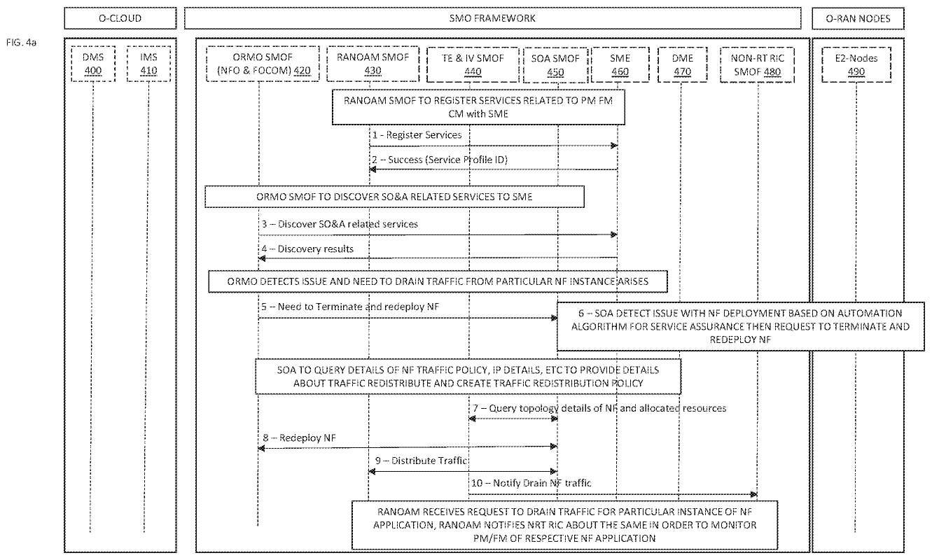

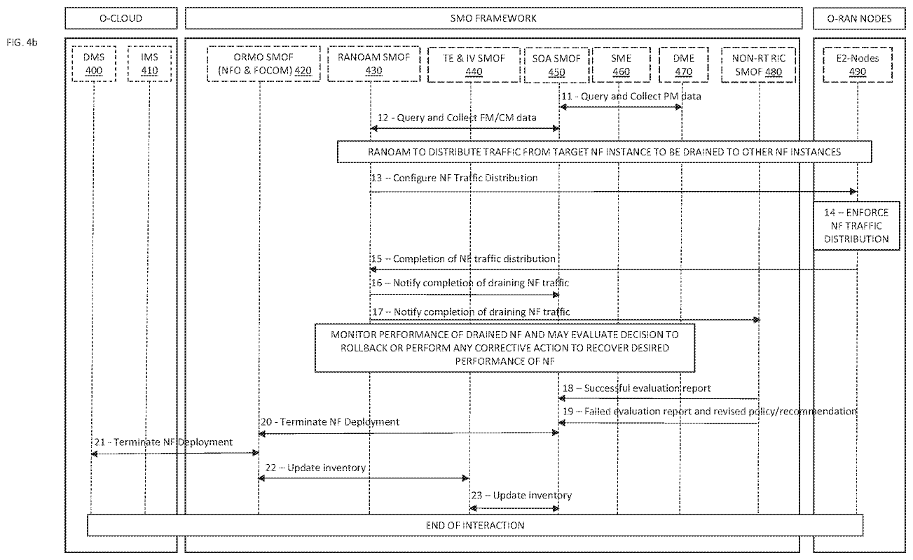

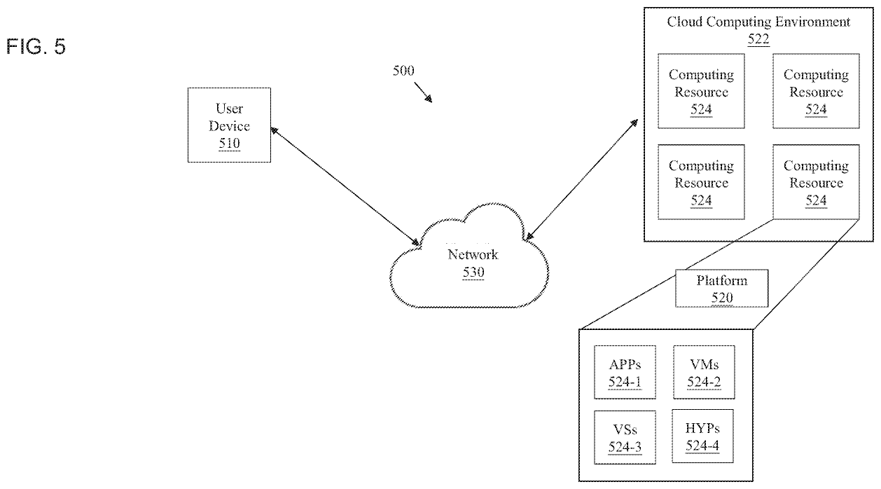

FIG. 5 is a diagram of an example environment 500 in which systems and/or methods, described herein, may be implemented. As shown in FIG. 5, environment 500 may include a user device 510, a platform 520, and a network 530. Devices of environment 500 may interconnect via wired connections, wireless connections, or a combination of wired and wireless connections. In embodiments, any of the functions and operations described with reference to FIGS. 2 through 4 above may be performed by any combination of elements illustrated in FIG. 5.

User device 510 includes one or more devices capable of receiving, generating, storing, processing, and/or providing information associated with platform 520. For example, user device 510 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 510 may receive information from and/or transmit information to platform 520.

Platform 520 includes one or more devices capable of receiving, generating, storing, processing, and/or providing information. In some implementations, platform 520 may include a cloud server or a group of cloud servers. In some implementations, platform 520 may be designed to be modular such that certain software components may be swapped in or out depending on a particular need. As such, platform 520 may be easily and/or quickly reconfigured for different uses.

In some implementations, as shown, platform 520 may be hosted in cloud computing environment 522. Notably, while implementations described herein describe platform 520 as being hosted in cloud computing environment 522, in some implementations, platform 520 may not be cloud-based (i.e., may be implemented outside of a cloud computing environment) or may be partially cloud-based.

Cloud computing environment 522 includes an environment that hosts platform 520. Cloud computing environment 522 may provide computation, software, data access, storage, etc., services that do not require end-user (e.g., user device 510) knowledge of a physical location and configuration of system(s) and/or device(s) that hosts platform 520. As shown, cloud computing environment 522 may include a group of computing resources 524 (referred to collectively as “computing resources 524” and individually as “computing resource 524”).

Computing resource 524 includes one or more personal computers, a cluster of computing devices, workstation computers, server devices, or other types of computation and/or communication devices. In some implementations, computing resource 524 may host platform 520. The cloud resources may include compute instances executing in computing resource 524, storage devices provided in computing resource 524, data transfer devices provided by computing resource 524, etc. In some implementations, computing resource 524 may communicate with other computing resources 524 via wired connections, wireless connections, or a combination of wired and wireless connections.

As further shown in FIG. 5, computing resource 524 includes a group of cloud resources, such as one or more applications (“APPs”) 524-1, one or more virtual machines (“VMs”) 524-2, virtualized storage (“VSs”) 524-3, one or more hypervisors (“HYPs”) 524-4, or the like. While the current example embodiment is with reference to virtualized network functions, it is understood that one or more other embodiments are not limited thereto, and may be implemented in at least one of containers, cloud-native services, one or more container platforms, etc. For example, in one or more other example embodiments, any of the above-described components (e.g., nodes, E2 nodes, SMO functions, RIC, system, apparatus, etc.) may be a software-based component deployed or hosted in, for example, a server cluster such as a hybrid cloud server, data center servers, and the like. The software-based component may be containerized and may be deployed and controlled by one or more machines, called “nodes”, that run or execute the containerized network elements and are addressable. In this regard, a server cluster may contain at least one master node and a plurality of worker nodes, wherein the master node(s) controls and manages a set of associated worker nodes

Application 524-1 includes one or more software applications that may be provided to or accessed by user device 510. Application 524-1 may eliminate a need to install and execute the software applications on user device 510. For example, application 524-1 may include software associated with platform 520 and/or any other software capable of being provided via cloud computing environment 522. In some implementations, one application 524-1 may send/receive information to/from one or more other applications 524-1, via virtual machine 524-2.

Virtual machine 524-2 includes a software implementation of a machine (e.g., a computer) that executes programs like a physical machine. Virtual machine 524-2 may be either a system virtual machine or a process virtual machine, depending upon use and degree of correspondence to any real machine by virtual machine 524-2. A system virtual machine may provide a complete system platform that supports execution of a complete operating system (“OS”). A process virtual machine may execute a single program, and may support a single process. In some implementations, virtual machine 524-2 may execute on behalf of a user (e.g., user device 510), and may manage infrastructure of cloud computing environment 522, such as data management, synchronization, or long-duration data transfers.

Virtualized storage 524-3 includes one or more storage systems and/or one or more devices that use virtualization techniques within the storage systems or devices of computing resource 524. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 524-4 may provide hardware virtualization techniques that allow multiple operating systems (e.g., “guest operating systems”) to execute concurrently on a host computer, such as computing resource 524. Hypervisor 524-4 may present a virtual operating platform to the guest operating systems, and may manage the execution of the guest operating systems. Multiple instances of a variety of operating systems may share virtualized hardware resources.

Network 530 includes one or more wired and/or wireless networks. For example, network 530 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

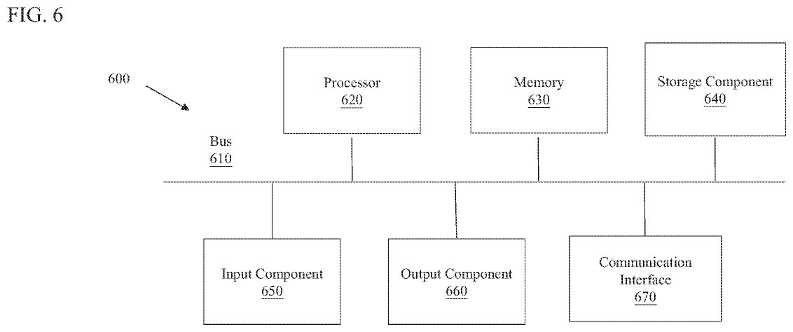

FIG. 6 is a diagram of example components of a device 600. Device 600 may correspond to user device 510 and/or platform 520. As shown in FIG. 6, device 600 may include a bus 610, a processor 620, a memory 630, a storage component 640, an input component 650, an output component 660, and a communication interface 670.

Bus 610 includes a component that permits communication among the components of device 600. Processor 620 may be implemented in hardware, firmware, or a combination of hardware and software. Processor 620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 includes one or more processors capable of being programmed to perform a function. Memory 630 includes a random access memory (RAM), a read only memory (ROM), and/or another type of dynamic or static storage device (e.g., a flash memory, a magnetic memory, and/or an optical memory) that stores information and/or instructions for use by processor 620.

Storage component 640 stores information and/or software related to the operation and use of device 600. For example, storage component 640 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 650 includes a component that permits device 600 to receive information, such as via user input (e.g., a touch screen display, a keyboard, a keypad, a mouse, a button, a switch, and/or a microphone). Additionally, or alternatively, input component 650 may include a sensor for sensing information (e.g., a global positioning system (GPS) component, an accelerometer, a gyroscope, and/or an actuator). Output component 660 includes a component that provides output information from device 600 (e.g., a display, a speaker, and/or one or more light-emitting diodes (LEDs)).

Communication interface 670 includes a transceiver-like component (e.g., a transceiver and/or a separate receiver and transmitter) that enables device 600 to communicate with other devices, such as via a wired connection, a wireless connection, or a combination of wired and wireless connections. Communication interface 670 may permit device 600 to receive information from another device and/or provide information to another device. For example, communication interface 670 may include an Ethernet interface, an optical interface, a coaxial interface, an infrared interface, a radio frequency (RF) interface, a universal serial bus (USB) interface, a Wi-Fi interface, a cellular network interface, or the like.

Device 600 may perform one or more processes described herein. Device 600 may perform these processes in response to processor 620 executing software instructions stored by a non-transitory computer-readable medium, such as memory 630 and/or storage component 640. A computer-readable medium is defined herein as a non-transitory memory device. A memory device includes memory space within a single physical storage device or memory space spread across multiple physical storage devices.

Software instructions may be read into memory 630 and/or storage component 640 from another computer-readable medium or from another device via communication interface 670. When executed, software instructions stored in memory 630 and/or storage component 640 may cause processor 620 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

In embodiments, any of the operations or processes of FIGS. 2-4 may be implemented by or using any one of the elements illustrated in FIGS. 5 and 6. It is understood that other embodiments are not limited thereto, and may be implemented in a variety of different architectures (e.g., bare metal architecture, any cloud-based architecture or deployment architecture such as Kubernetes, Docker, OpenStack, etc.).

A use case in accordance with one or more example embodiments is described further herein below.

Use Case: ORMO & RANOAM SMOF Interactions

### Background and Goal of the Use Case

O-Cloud orchestration and managements require seamless interactions with other

SMO functions such as RANOAM, TE & IV, Non-RT RIC SMOF. This use case focuses on interactions with RAN OAM SMOF.

Network functions are orchestrated by NFO related capabilities of ORMO; however those NF application are configured through RAN OAM via O1 interface. In case of Scale In of NF, before terminating any NF deployment, i.e., NF instance traffic associated with that NF deployment needs to distribute amongst remaining NF deployment. Here NFO needs to instruct RAN OAM to drain traffic of NF deployment which is to be terminated. RAN OAM to ascertain policy to distribute traffic among NF deployment through other SMOF such NFO, Non-RT RIC, TE &IV or RAN OAM.

NF traffic draining is an example of interaction required between ORMO & RAN OAM, there could be more examples such as:

NFO→RANOAM: Configuring or Reconfiguring NF post NF instantiation by DMS.

NFO→RANOAM: Querying operational, administrative, usage state of NF.

NFO→RANOAM: Notification related to NF state & health.

NFO→RANOAM: Response to actions initiated by RANOAM.

RANOAM→NFO: Notification related to NF Configuration, Traffic draining, Fault reporting.

Below capabilities are essential for O-Cloud Orchestration and Management in relation with interaction with other RAN OAM:

FOCOM/NFO to support for capabilities to receive notifications from RANOAM.

FOCOM/NFO to support for capability to configure NF deployment through RAN OAM.

RAN OAM to support capabilities to receive notifications from ORMO SMOF.

RAN OAM to support capabilities to send notifications to other SMOF.

### Entities/Resources Involved in the Use Case

### 1) SME SMOF:

a) In a decoupled service-based SMO architecture, the SME can be leveraged as a universal SMOS, handling service management and exposure for any SMOSs within SMO.
b) To support functionality to discover the available services from SMOF and authorization of SMOF to determine which services an SMOF can discover,
c) Support to retrieve the stored service information and performs filtering of available services based on selection criteria that may be provided by the SMOF.

### 2) Non-RT RIC SMOF

a) Support to monitor and evaluate NF PM/FM/CM data via O1 & O2 for NF traffic draining.

### 3) ORMO SMOF (NFO & FOCOM)

a) Support registration of capabilities for NFO related services such as with SME.
b) Support receiving and sending necessary notifications for RANOAM SMOF related to life cycle of NF deployment.

### 4) O-Cloud (IMS & DMS)

a) Support to receive actions and feedback from ORMO SMOF (NFO & FOCOM) & implement on O-Cloud platform through IMS & DMS

### 5) Topology Exposure and Inventory Management (TE & IV) SMOF

a) Support updating Topology Exposure and Inventory based on request from other SMOF.

### 6) RAN OAM SMOF

a) Supports requests from other SMOF for services such as PM, FM, CM.
b) Notifying other SMOF about mentioned changes in CM requests
   7) Service Orchestrator (SO) and Service assurance (SA) SMOF
a) Support orchestrating various procedures required for interaction between RAN OAM related function and NFO/FOCOM based services assurance.
b) The SO uses a set of recipes to define the steps involved in creating a service, and it then executes these steps in a sequence to ensure that the service is created correctly.
c) The SO and SA work together to ensure that network services are created and maintained in a consistent and reliable manner. The SO ensures that the services are created correctly, and the SA ensures that they are performing as expected. This helps to improve the overall quality of service for network customers.

Scenario 1: RAN OAM SMOF to NFO/FOCOM
Interaction without SO and rApp as SA

| Use Case | |
|---|---|
| Stage | Evolution/Specification |
| Goal | Enabling CM interactions between ORAMF and RANOAMF |
| Actors and | SME: Service exposure Entity |
| Roles | Non-RT RIC: Analytical Function |
| | ORMO SMOF (Including NFO & FOCOM): O-Cloud |
| | Orchestration and Management function. |
| | RAN OAMF: CM Enforcement Entity |
| Assumptions | O2 interface connectivity is established between SMO and O- |
| | Cloud |
| | O1 interface connectivity is established. |
| | Network is operational. |
| Pre-conditions | ORMOF Initiated O2 procedures as mentioned O-RAN- |
| | WG6.ORCH-USE-CASES in Section 3.2 |
| Begins when | ORMOF initiates request to RAN OAMF. |
| Step 1 (M) | The RANOAM SMOF registers its services related to PM, FM, |
| | and CM with the SME. |
| Step 2 (M) | The ORMO SMOF (NFO/FOCOM) discovers the RANOAM- |
| | related services with the SME. |
| Step 3 (M) | The ORMO SMOF initiates the traffic draining process by |
| | sending a request to the OAM. |
| Step 4 (M) | The OAM notifies the nRT about the traffic draining request. |
| Step 5 (M) | The nRT queries and collects the PM data from the DME. |
| Step 6(M) | The nRT queries and collects the FM/CM data from the OAM. |
| Step 7 (M) | The OAM configures the NF traffic distribution on the E2-Nodes. |
| Step 8 (M) | The E2-Nodes enforce the NF traffic distribution. |
| Step 9 (M) | The E2-Nodes notify the OAM about the completion of the NF |
| | traffic distribution. |
| Step 10 (M) | The OAM notifies the nRT about the completion of the NF traffic |
| | draining. |
| Step 11 (O) | The nRT evaluates the performance of the drained NF and |
| | decides whether to rollback or take any corrective action to |
| | recover the desired performance of the NF. |
| Step 12 (O) | If the nRT decides to rollback, it sends a report to the OAM. |
| Step 13 (M) | The OAM terminates the NF deployment by sending a request to |
| | the DMS. |
| Step 14 (M) | The ORMO SMOF updates the inventory with the TEIV. |
| Ends when | O-Cloud becomes non-operational or when the operator disables |
| | the rApp as policy function or ML model for policy function. |
| Exceptions | TBD |
| Post | End |
| Conditions | |

```
  @startuml
  ′https://plantuml.com/sequence-diagram
  !pragma teoz true
  skinparam ParticipantPadding 5
  skinparam BoxPadding 10
  skinparam defaultFontSize 12
  skinparam lifelineStrategy solid
  autonumber
  Box “O-Cloud” #lightseagreen
    participant “DMS” as DMS
    participant “IMS” as IMS
  End box
  Box ″Service Management and Orchestration Framework″ #gold
    Participant “ORMO SMOF\n(NFO & FOCOM)” as ORMO
    Participant “RANOAM SMOF” as OAM
    Participant “TE & IV SMOF” as TEIV
    Participant “SME” as SME
    Participant “DME” as DME
    Participant “Non-RT RIC SMOF” as nRT
  End box
  Box ″ O-RAN Nodes″ #lightpink
      Participant ″E2-Node(s)″ as E2NODES
  End box
  group Service registeration
  Note over OAM
  RANOAM SMOF to register services
  Related to PM, FM ,CM with SME
  End note
    OAM −> SME : Register services
    SME −> OAM : Success (Service Profile ID)
  end
  group Service discovery
  Note over ORMO , SME
  ORMO SMOF i.e. NFO /FOCOM tp discover RANOAM related to
  services with SME .
  End note
    ORMO −> SME : <<R1>> Discover RANOAM SMOF
    Related services
    SME −> ORMO : <<R1>> Discovery Result
  end
  group ORMO to OAM Interaction for Traffic Draining
  Note over ORMO, OAM
  There are possible interactions such as there is need to
  to drain traffic from perticular instace of NF application
  End note
  Alt ORMO Initiates
    ORMO −> OAM : Drain NF traffic
  Else Non-RT RIC Initiates
    OAM −> nRT : Notify Drain NF traffic
  Note over OAM, nRT
  RANAOM receives request to drain traffic for particular instance
  of NF application
RANOAM
  Notifies nRT about same in order to monitor PM/FM of respective
  NF application
  End note
    nRT <-> DME : Query & collect PM Data
  nRT <-> OAM : Query & collect FM/CM Data
  Note over OAM, E2NODES
  RANOAM to distribute traffic from target NF instance to be drained
  to other instances of
NF instances
  End Note
  OAM −> E2NODES : <<O1>> Configure NF Traffic Distribution
  E2NODES −> E2NODES : Enforce NF\nTraffic Distribution
  E2NODES −> OAM : <<O1>> Completion of NF Traffic Distribution
  OAM −> nRT : Notify Completion of Drain NF traffic
  Note Over nRT , OAM
  Monitor performance of drained NF & evaluate
  Decision to rollback or any corrective action
  to recover desired performance of NF
  end note
  nRT −> nRT : Evaluate\nPerformance of NF
  nRT −> OAM : Successful Evaluation Report
  OAM −> ORMO : Completion of NF traffic draining
  ORMO −> DMS : Terminate NF Deployement
  end
  group Inventory Update
  ORMO <-> TEIV : Update Inventory
  End
  @enduml
```

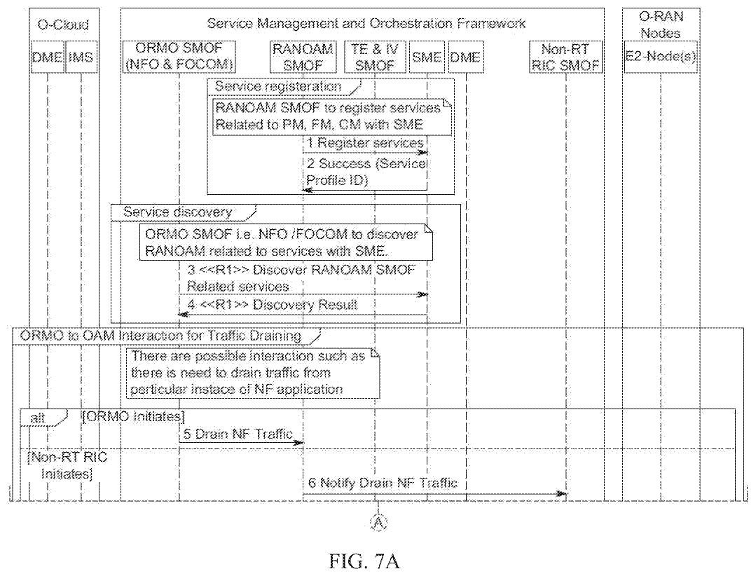

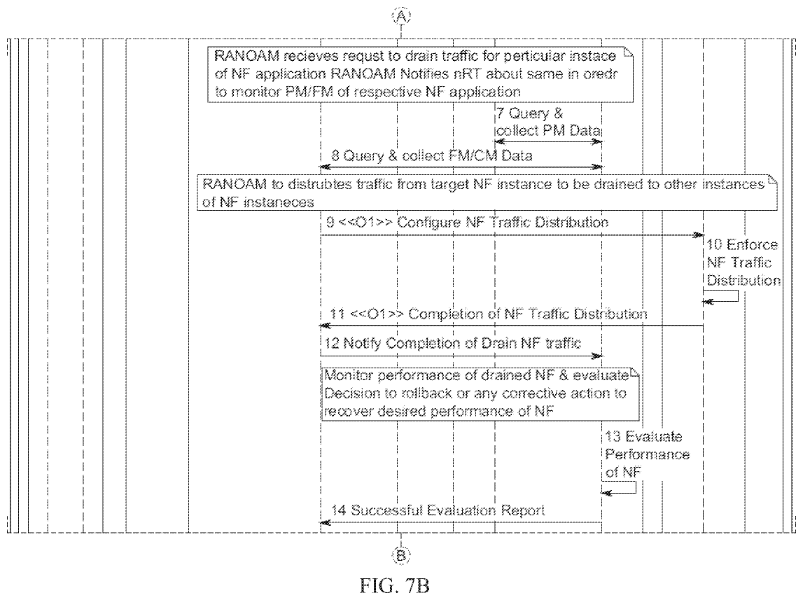

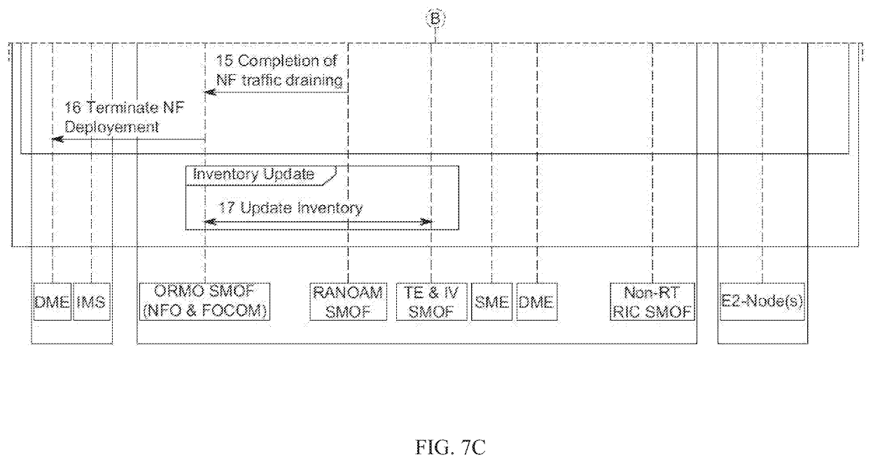

FIG. 7A-FIG. 7C illustrates a callflow diagram for an interaction between ORMO and RANOAM SMOF according to an embodiment. FIG. 7A-FIG. 7C may illustrate a use case for scenario 1.

Scenario 2: RAN OAM SMOF to NFO/FOCOM
Interaction with SO and rApp as SA

| Use Case | |
|---|---|
| Stage | Evolution/Specification |
| Goal | Enabling CM interactions between ORAMF and RANOAMF |
| Actors and | SME: Service exposure Entity |
| Roles | Non-RT RIC: Analytical Function |
| | ORMO SMOF (Including NFO & FOCOM): O-Cloud |
| | Orchestration and Management function. |
| | RAN OAMF: CM Enforcement Entity |
| | SO SMOF: Service orchestration entity |
| Assumptions | O2 interface connectivity is established between SMO and O- |
| | Cloud |
| | O1 interface connectivity is established. |
| | Network is operational. |
| Pre-conditions | ORMOF Initiated O2 procedures as mentioned O-RAN- |
| | WG6.ORCH-USE-CASES in Section 3.2 |
| Begins when | ORMOF initiates request to SO SMOF. |
| Step 1 (M) | The RANOAM SMOF registers its services related to PM, FM, |
| | and CM with the SME. |
| Step 2 (M) | The ORMO SMOF (NFO/FOCOM) discovers the SO related to |
| | services with the SME. |
| Step 3 (M) | The ORMO SMOF or the Non-RT RIC initiates the NF |
| | termination and redeployment process by sending a request to the |
| | SO. |
| Step 4 (M) | The SO queries the TEIV for the topology details of the NF and |
| | the allocated resources. |
| Step 5 (M) | The SO redeploys the NF by sending a request to the ORMO. |
| Step 6(M) | The ORMO creates an NF instance by sending a request to the |
| | DMS. |
| Step 7 (M) | The ORMO notifies the SO about the creation of the NF instance. |
| Step 8 (M) | The SO notifies the OAM to drain the NF and redistribute the |
| | traffic. |
| Step 9 (M) | The OAM notifies the nRT about the NF draining request. |
| Step 10 (M) | The nRT queries and collects the PM data from the DME. |
| Step 11 (O) | The nRT queries and collects the FM/CM data from the OAM. |
| Step 12 (O) | The OAM configures the NF traffic distribution on the E2-Nodes. |
| Step 13 (M) | The E2-Nodes enforce the NF traffic distribution. |
| Step 14 (M) | The E2-Nodes notify the OAM about the completion of the NF |
| | traffic distribution. |
| Step 15 (M) | The OAM notifies the nRT about the completion of the NF |
| | draining. |
| Step 16 (M) | The nRT evaluates the performance of the drained NF and |
| | decides whether to rollback or take any corrective action to |
| | recover the desired performance of the NF. |
| Step 17 (M) | If the nRT decides to rollback, it sends a report to the SO. |
| Step 18 (M) | The SO executes the revised policy or recommendation, which |
| | may involve re-draining the NF and redistributing the traffic. |
| Step 19 (M) | The SO terminates the NF deployment by sending a request to the |
| | ORMO. |
| Step 20 (M) | The ORMO terminates the NF deployment by sending a request |
| | to the DMS. |
| Step 21 (M) | The ORMO or the SO updates the inventory with the TEIV. |
| Ends when | O-Cloud becomes non-operational or when the operator disables |
| | the rApp as policy function or ML model for policy function. |
| Exceptions | TBD |
| Post | End |
| Conditions | |

```
  @startuml
  ′https://plantuml.com/sequence-diagram
  !pragma teoz true
  skinparam ParticipantPadding 5
  skinparam BoxPadding 10
  skinparam defaultFontSize 12
  skinparam lifelineStrategy solid
  autonumber
  Box “O-Cloud” #lightseagreen
    participant “DMS” as DMS
    participant “IMS” as IMS
  End box
  Box ″Service Management and Orchestration Framework″ #gold
    Participant “ORMO SMOF\n(NFO & FOCOM)” as ORMO
    Participant “RANOAM SMOF” as OAM
    Participant “TE & IV SMOF” as TEIV
    Participant “SO SMOF” as SO
    Participant “SME” as SME
    Participant “DME” as DME
    Participant “Non-RT RIC SMOF” as nRT
  End box
  Box ″ O-RAN Nodes″ #lightpink
      Participant ″E2-Node(s)″ as E2NODES
  End box
  group Service registeration
  Note over OAM
  RANOAM SMOF to register services
  Related to PM, FM ,CM with SME
  End note
    OAM −> SME : Register services
    SME −> OAM : Success (Service Profile ID)
  end
  group Service discovery
  Note over ORMO , SME
  ORMO SMOF i.e. NFO /FOCOM to discover SO&A related to
  services with SME .
  End note
    ORMO −> SME : <<R1>> Discover SOA SMOF Related services
    SME −> ORMO : <<R1>> Discovery Result
  end
  Note over ORMO, OAM
  There are possible interactions such as there is need to
  to drain traffic from particular instance of NF application
  End note
  Alt ORMO Initiates
    ORMO −> SO : Terminating & Redeploy NF
  Else Non-RT RIC Initiates
  Note over nRT, SO
  Non-RT RIC can detect issue with NF deployment
  or O-Cloud and requesting to terminate and redeploy NF
  End note
    nRT −> SO : Terminating & redeploy NF
  end
  Note over SO, TEIV
  SO can query details of NF traffic policy , IP details, etc. to provide
  details
  about traffic redistribution . Non-RT RIC can provide traffic
  redistribution policy.
  End note
    SO <-> TEIV : Query Topology details of NF & allocated resources
    SO <-> ORMO : Redeploy NF
    ORMO <-> DMS : Create NF Instance
    ORMO <-> SO : Notify Creation of NF Instance
    SO <-> OAM : Drain NF and Redistribute Traffic
  Group Non-RT RIC Data collection
    SO −> nRT : Notify Drain NF traffic
  Note Left
  RANAOM receives request to drain traffic for particular instance
  of NF application
RANOAM
  SO Notifies nRT about same in order to monitor PM/FM of respective
  NF application
  End note
    nRT <-> DME : Query & collect PM Data
  nRT <-> OAM : Query & collect FM/CM Data
  Note over OAM, E2NODES
  RANOAM to distribute traffic from target NF instance to be drained
  to other instances of
NF
  End Note
  End
  Group RAN OAM executes traffic draining
  OAM −> E2NODES : <<O1>> Configure NF Traffic Distribution
  E2NODES −> E2NODES : Enforce NF\nTraffic Distribution
  E2NODES −> OAM : <<O1>> Completion of NF Traffic Distribution
  OAM −> SO : Notify Completion of Drain NF traffic
  OAM −> nRT : Notify Completion of Drain NF traffic
  End
  Group Non-RT RIC as Assurance
  nRT −> nRT : Evaluate\nPerformance of NF
  Note left
  Monitor performace of drained NF & evaluate
  Decision to rollback or any corrective action
  to recover desired performance of NF
  end note
  Alt Successful
  nRT −> SO : Successful Evaluation Report
  Else Failed
  nRT −> SO : Failed Evaluation Report & revised policy or
  recommendation
  Note Over SO, nRT
  SO to execute revised policy or recommendation in similar manner
  as mentioned on
previous steps
  end note
  End
  End
  SO <-> ORMO : Terminate NF Deployment
  ORMO <-> DMS : Terminate NF Deployment
  alt Inventory Update
  ORMO <-> TEIV : Update Inventory
  Else
  SO <-> TEIV : Update Inventory
  @enduml
```

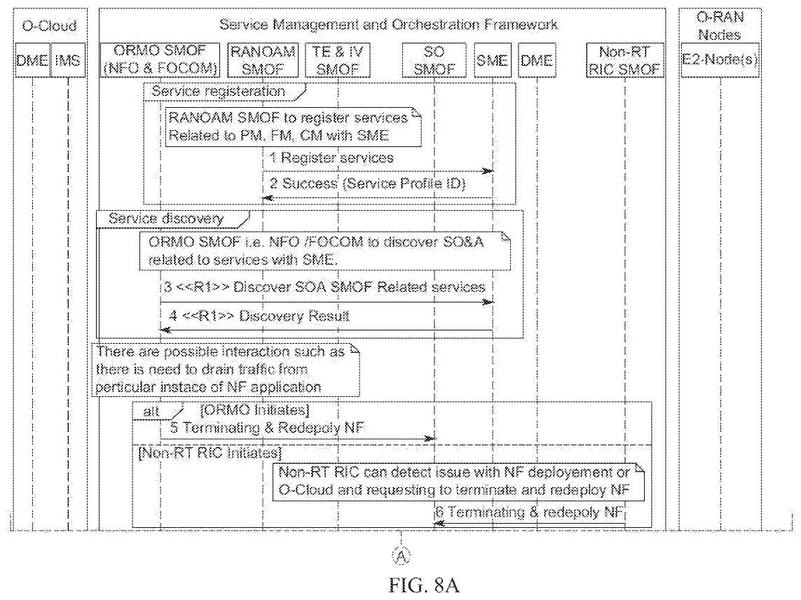

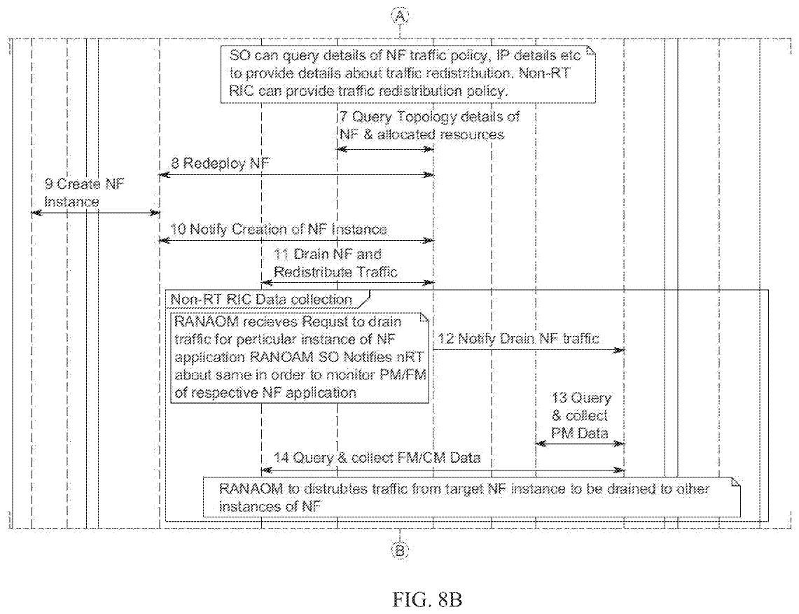

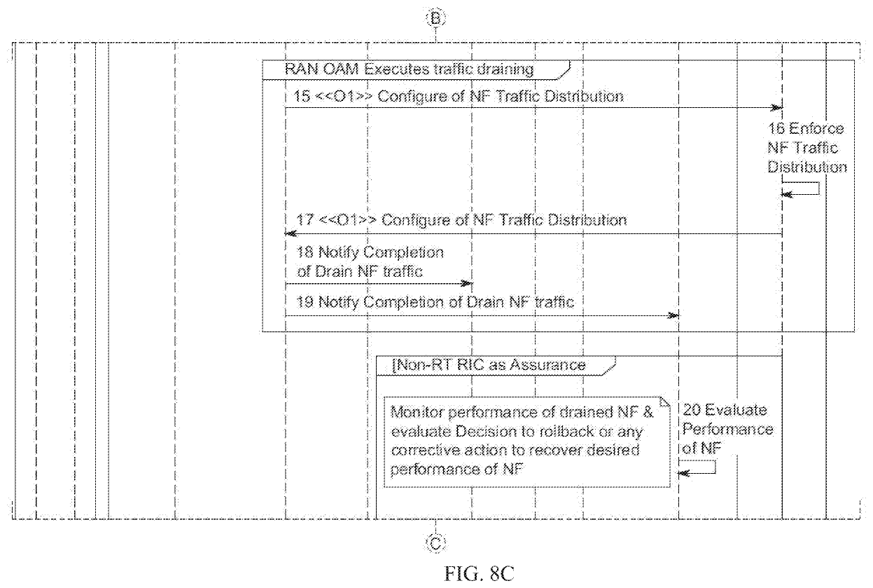

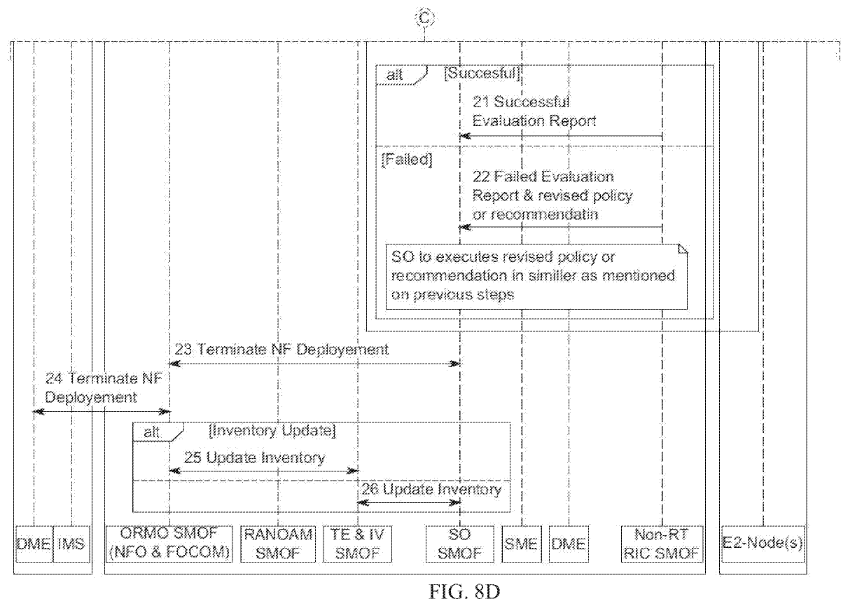

FIG. 8A-FIG. 8D illustrates a callflow diagram for an interaction between ORMO, RANOAM SMOF, including a SO SMOF according to an embodiment. FIG. 8A-FIG. 8D may illustrate a use case for scenario 2.

Scenario 3: RAN OAM SMOF to NFO/FOCOM Interaction with SOA

| Use Case Stage | Evolution/Specification |
|---|---|
| Goal | Enabling CM interactions between ORAMF and RANOAMF |
| Actors and Roles | SME: Service exposure Entity |
| | Non-RT RIC: Analytical Function |
| | ORMO SMOF (Including NFO & FOCOM): O-Cloud |
| | Orchestration and Management function. |
| | RAN OAMF: CM Enforcement Entity |
| | SOA SMOF: Service orchestration and assurance entity |
| Assumptions | O2 interface connectivity is established between SMO and O- |
| | Cloud |
| | O1 interface connectivity is established. |
| | Network is operational. |
| Pre-conditions | ORMOF Initiated O2 procedures as mentioned O-RAN- |
| | WG6.ORCH-USE-CASES in Section 3.2 |
| Begins when | ORMOF initiates request to SOA SMOF. |
| Step 1 (M) | The RANOAM SMOF registers its services related to PM, |
| | FM, and CM with the SME. |
| Step 2 (M) | The ORMO SMOF (NFO/FOCOM) discovers the SO&A |
| | related to services with the SME. |
| Step 3 (M) | The ORMO SMOF or the SOA SMOF initiates the NF |
| | termination and redeployment process by sending a |
| | request to the SOA. |
| Step 4 (M) | The SOA queries the TEIV for the resource details of the NF. |
| Step 5 (M) | The SOA redeploys the NF by sending a request to the ORMO. |
| Step 6(M) | The SOA distributes the traffic by sending a request to the |
| | OAM. |
| Step 7 (M) | The OAM notifies the nRT about the NF draining request. |
| Step 8 (M) | The nRT queries and collects the PM data from the DME. |
| Step 9 (M) | The nRT queries and collects the FM/CM data from the OAM. |
| Step 10 (M) | The OAM configures the NF traffic distribution on the E2- |
| | Nodes. |
| Step 11 (O) | The E2-Nodes enforce the NF traffic distribution. |
| Step 12 (O) | The E2-Nodes notify the OAM about the completion of the NF |
| | traffic distribution. |
| Step 13 (M) | The OAM notifies the nRT about the completion of the NF |
| | draining. |
| Step 14 (M) | The SOA evaluates the performance of the drained NF and |
| | decides whether to rollback or take any corrective |
| | action to recover the desired performance of the NF. |
| Step 15 (M) | If the SOA decides to rollback, it sends a report to itself. |
| Step 16 (M) | The SOA executes the revised policy or recommendation, |
| | which may involve re-draining the NF and |
| | redistributing the traffic. |
| Step 17 (M) | The SOA terminates the NF deployment by sending a request |
| | to the ORMO. |
| Step 18 (M) | The ORMO terminates the NF deployment by sending a |
| | request to the DMS. |
| Step 19 (M) | The ORMO or the SOA updates the inventory with the TEIV. |
| Ends when | O-Cloud becomes non-operational or when the operator |
| | disables the rApp as policy function or ML model for |
| | policy function. |
| Exceptions | TBD |
| Post Conditions | End |

```
  @startuml
    ′https://plantuml.com/sequence-diagram
    !pragma teoz true
    skinparam ParticipantPadding 5
    skinparam BoxPadding 10
    skinparam defaultFontSize 12
    skinparam lifelineStrategy solid
    autonumber
  Box “O-Cloud” #lightseagreen
    participant “DMS” as DMS
    participant “IMS” as IMS
  End box
  Box ″Service Management and Orchestration Framework″ #gold
    Participant “ORMO SMOF\n(NFO & FOCOM)” as ORMO
    Participant “RANOAM SMOF” as OAM
    Participant “TE & IV SMOF” as TEIV
    Participant “SOA SMOF” as SOA
    Participant “SME” as SME
    Participant “DME” as DME
    Participant “Non-RT RIC SMOF” as nRT
  End box
  Box ″ O-RAN Nodes″ #lightpink
      Participant ″E2-Node(s)″ as E2NODES
  End box
  group Service registeration
  Note over OAM
  RANOAM SMOF to register services
  Related to PM, FM ,CM with SME
  End note
    OAM −> SME : Register services
    SME −> OAM : Success (Service Profile ID)
  end
  group Service discovery
  Note over ORMO , SME
  ORMO SMOF i.e. NFO /FOCOM to discover SO&A related to
  services with SME .
  End note
    ORMO −> SME : <<R1>> Discover SOA SMOF Related services
    SME −> ORMO : <<R1>> Discovery Result
  end
  Alt ORMO Initiates
  Note over ORMO, SOA
  ORMO detect issue and there is need to drain traffic from particular
  instance of NF
application
  End note
    ORMO −> SOA : Need to Terminate & Redeploy NF
  Else SOA Initiates
  Note over ORMO, SOA
  SO can detect issue with NF deployment based on automation
  algorithm
  For service assurance ,then requesting to terminate and
  redeploy NF
  End note
    SOA −> SOA : Terminating & redeploy NF
  end
  Note over TEIV, SOA
  SO to query details of NF traffic policy , IP details, etc., to
  provide details
  about traffic redistribution . Create traffic redistribution policy.
  End note
    SOA <-> TEIV : Query Resource details of NF
    SOA <-> ORMO : Redeploy NF
    SOA <-> OAM : Distribute Traffic
    SOA −> nRT : Notify Drain NF traffic
  Note over OAM, nRT
  RANAOM receives request to drain traffic for particular instance
  of NF application
RANOAM
  Notifies nRT about same in order to monitor PM/FM of respective
  NF application
  End note
  Group SOA Data collection
    SOA <-> DME : Query & collect PM Data
    SOA <-> OAM : Query & collect FM/CM Data
  End
  Group RAN OAM Executes traffic draining
  Note over OAM, E2NODES
  RANOAM to distributes traffic from target NF instance to be drained
  to other instances
of NF instances
  End Note
    OAM −> E2NODES : <<O1>> Configure NF Traffic Distribution
    E2NODES −> E2NODES : Enforce NF\nTraffic Distribution
    E2NODES −> OAM : <<O1>> Completion of NF Traffic Distribution
    OAM −> SOA : Notify Completion of Drain NF traffic
    OAM −> nRT : Notify Completion of Drain NF traffic
  End
  Alt Successful
  Note Over SOA
  Monitor performance of drained NF & evaluate
  Decision to rollback or any corrective action
  to recover desired performance of NF
  end note
    SOA −> SOA : Successful Evaluation Report
  Else Failed
    SOA −> SOA : Failed Evaluation Report &\n revised policy
    or recommendation
  End
    SOA <-> ORMO : Terminate NF Deployment
    ORMO <-> DMS : Terminate NF Deployment
  alt Inventory Update
    ORMO <-> TEIV : Update Inventory
  Else
    SOA <-> TEIV : Update Inventory
  End
  @enduml
```

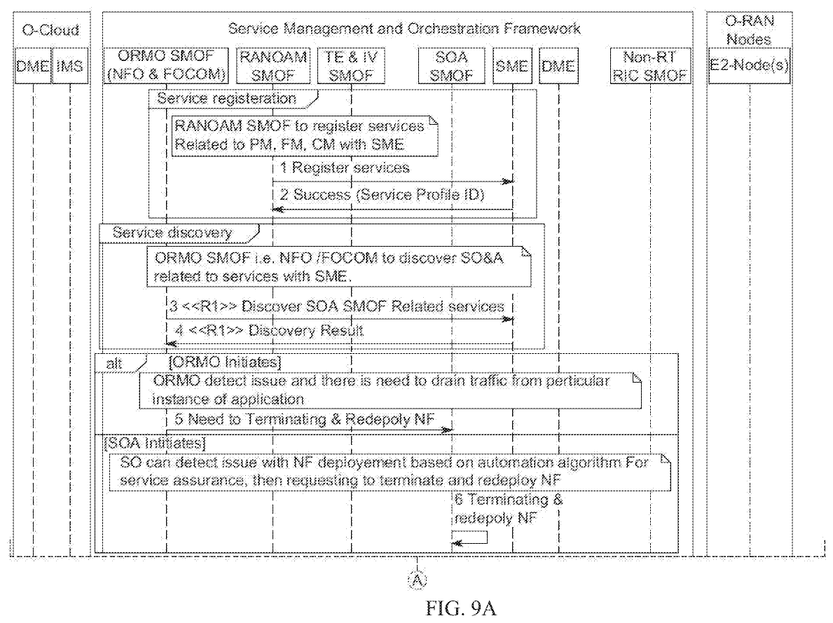

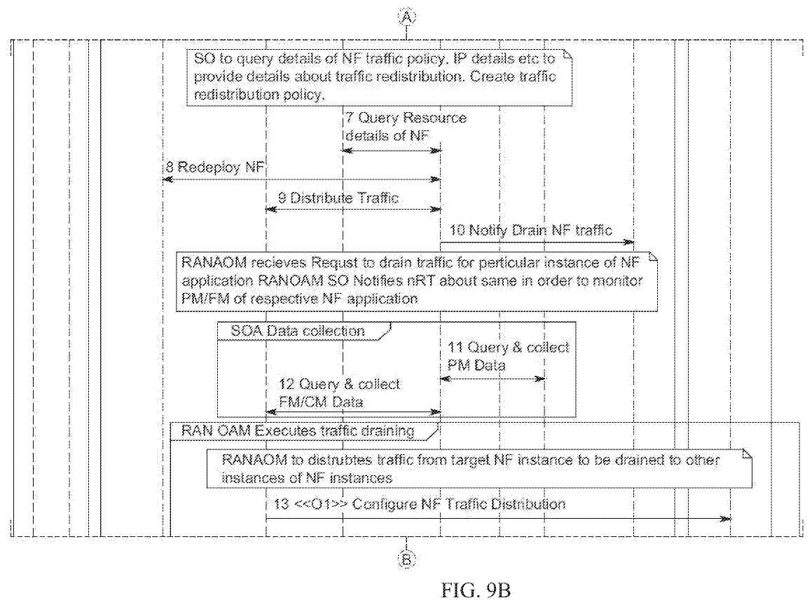

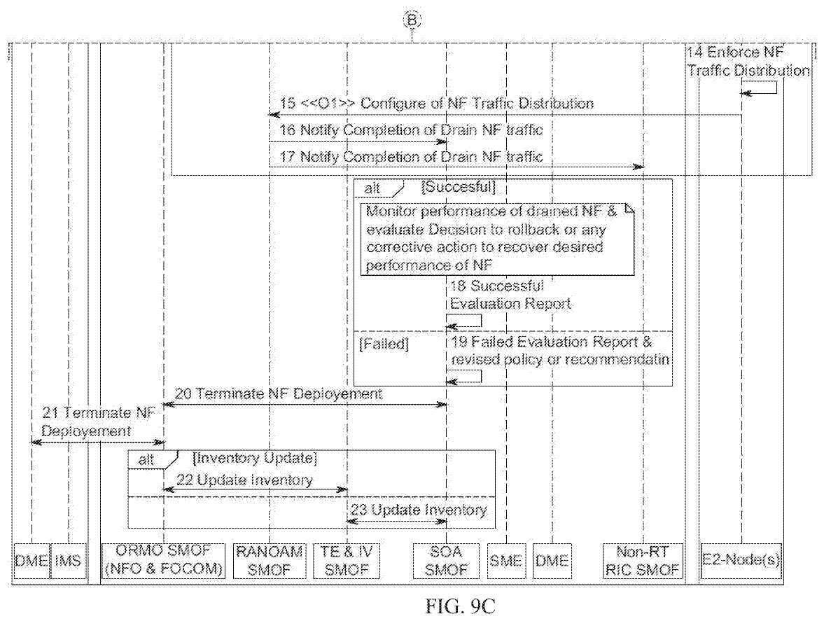

FIG. 9A-FIG. 9C illustrates a callflow diagram for an interaction between ORMO, RANOAM SMOF, including an SOA SMOF according to an embodiment. FIG. 9A-FIG. 9C may illustrate a use case for scenario 3.

### 7 Recommended Functional Requirements

7.x ORMOF Requirements

| | | |
|---|---|---|
| REQ | Description | Note |

| | |
|---|---|
| [REQ- ORMOF -001] | ORMOF shall support registration of NFO and/or FOCOM |
| | related services with SME SMOF. |
| [REQ- ORMOF -002] | ORMOF shall support traffic draining request for cases such as NF |
| | termination towards Service Orchestrator and Assurance. |
| [REQ- ORMOF -003] | ORMOF shall support invoking O2DMS/O2IMS actions based on |
| | SOA or SO recommendations. |
| [REQ- ORMOF -004] | ORMOF shall support acknowledge notifications related to RAN |
| | OAM SMOF |

7.x NRTRF Requirements

| | | |
|---|---|---|
| REQ | Description | Note |

| | |
|---|---|
| [REQ- NRTF -001] | NRTRF shall support role of assurance for SOF in cases such as |
| | NF traffic draining. |
| [REQ- NRTF -002] | NRTRF shall support discovery of SOF or SOAF related services |
| | over SME |

7.x SOAF Requirements

| | | |
|---|---|---|
| REQ | Description | Note |

| | |
|---|---|
| [REQ- SOAF -001] | SOAF shall support registration of SOA related services over |
| | SME. |
| [REQ- SOAF -002] | SOAF shall support discovery of SOA related services through |
| | SME. |
| [REQ- SOAF -003] | SOAF shall support role of services orchestrator to facilitate |
| | procedures between various SMOF within SMO. |
| [REQ- SOAF -004] | SOAF shall support role of services assurance to enable SLA |
| | based procedures within SMO. |
| [REQ- SOAF -005] | SOAF shall support ORMOF and RAN OAMF related data |
| | collection. |
| [REQ- SOAF -006] | SOAF shall support storing relevant end to end NF application |
| | related, O-Cloud Infrastructure related, NF deployment related |
| | automation procedures and registering it over SME/DME for |
| | discovery purpose. |

7.x SOF Requirements

| | | |
|---|---|---|
| REQ | Description | Note |

| | |
|---|---|
| [REQ- SOAF -001] | SOF shall support role of services orchestrator to facilitate |
| | procedures between various SMOF within SMO. |
| [REQ- SOAF -002] | SOF shall support registration of SO related services over SME. |
| [REQ- SOAF -003] | SOF shall support discovery of SO related services through SME. |
| [REQ- SOAF -004] | SOF shall support storing relevant end to end NF application |
| | related, O-Cloud Infrastructure related, NF deployment related |
| | automation procedures and registering it over SME/DME for |
| | discovery purpose. |

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

These computer readable program instructions may also be loaded onto a computer, other programmable data processing apparatus, or other devices to cause a series of operational steps to be performed on the computer, other programmable apparatus or other devices to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which includes one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

### Various Aspects of Embodiments

Various further respective aspects and features of embodiments of the present disclosure may be defined by the following items:

Item [1]; A method for managing interactions between an O-Cloud Resources Management and Orchestration (ORMO) Service Management Orchestration Function (SMOF) and a Radio Access Network Operations Administration Maintenance (RANOAM) function, the method including: receiving, by the ORMO, related services to the an SMOF from a Service Management and Exposure (SME); sending, by the ORMO, a request to the SMOF to drain traffic of at least one network function (NF); and sending, by the ORMO, a request to a Topology Exposure and Inventory Management (TE/IV) to update an inventory.

Item [2]: The method according to item [1], wherein the SMOF is the RANOAM SMOF, and wherein upon receiving the request from the ORMO, the RANOAM SMOF is configured to notify a non Real-Time (nRT) RIC SMOF about the request to drain traffic of the at least one NF, wherein the nRT RIC SMOF is configured to query and collect Performance Management (PM) data from a Data Management Entity (DME) and Fault Management (FM) and Configuration Management (CM) data from the RANOAM SMOF upon being notified about the request to drain traffic of the at least one NF.

Item [3]: The method according to item [2], wherein upon receiving the FM and CM data, the RANOAM SMOF is configured to send a NF traffic distribution configuration to E2 nodes, wherein the E2 nodes are configured to enforce NF traffic distribution based on the NF traffic distribution configuration to drain the at least one NF and send a notification of completing enforcing the NF traffic distribution to the RANOAM SMOF.

Item [4]: The method according to item [3], wherein upon receiving the notification of completing the NF traffic distribution, the RANOAM SMOF is configured to forward the notification of completing the NF traffic distribution to the nRT RIC SMOF.

Item [5]: The method according to item [4], wherein upon receiving the notification of completing the NF traffic distribution from the RANOAM SMOF, the nRT RIC SMOF is configured to evaluate the performance of the drained at least one NF, and based on the evaluated performance, send a report to the RANOAM SMOF recommending whether or not to rollback the NF traffic distribution configuration.

Item [6]: The method according to item [5], wherein upon receiving the report, the RANOAM SMOF is configured to send a notification to the ORMO indicating traffic draining was completed.

Item [7]: The method according to item [6], wherein upon receiving the notification from the RANOAM SMOF, the method further includes: sending, by the ORMO, a request to the DMS to terminate a deployment of the at least one NF.

Item [8]: A method for managing interactions between an O-Cloud Resources Management and Orchestration (ORMO) Service Management Orchestration Function (SMOF) and a Radio Access Network Operations Administration Maintenance (RANOAM) function, the method including: receiving, by the ORMO, a service related to a Service Orchestration (SO) SMOF from a Service Management and Exposure (SME); sending, by the ORMO, a request to the SO SMOF to terminate and redeploy at least one network function (NF); and sending, by the ORMO, a request to a Topology Exposure and Inventory Management (TE/IV) to update an inventory.

Item [9]: The method according to item [8]. wherein upon receiving the request from the ORMO, the SO SMOF is configured to query topology details of the at least one NF and allocated resources from the TE/IV and send a request to the ORMO to redeploy the at least one NF.

Item [10]: The method according to item [9], wherein upon receiving the request from the SO SMOF to redeploy the at least one NF, the method further includes: sending, by the ORMO, a request to a Deployment Management Services (DMS) to create a new NF instance; and sending, by the ORMO, a notification to the SO SMOF that the new NF instance was created.

Item [11]. The method according to item [10], wherein upon receiving the notification from the ORMO that the new NF instance was created, the SO SMOF is configured to send a request to a RANOAM SMOF to drain the at least one NF, wherein upon receiving the request from the SO SMOF to drain the at least one NF, the RANOAM SMOF is configured to notify a non Real-Time (nRT) RIC SMOF about the request to drain traffic of the at least one NF, wherein the nRT RIC SMOF is configured to query and collect Performance Management (PM) data from a Data Management Entity (DME) and Fault Management (FM) and Configuration Management (CM) data from the RANOAM SMOF upon being notified about the request to drain traffic of the at least one NF.

Item [12]: The method according to item [11], wherein upon receiving the FM and CM data, the RANOAM SMOF is configured to send a NF traffic distribution configuration to E2 nodes, wherein the E2 nodes are configured to enforce NF traffic distribution based on the NF traffic distribution configuration to drain the at least one NF and send a notification of completing enforcing the NF traffic distribution to the RANOAM SMOF, wherein upon receiving the notification of completing the NF traffic distribution, the RANOAM SMOF is configured to forward the notification of completing the NF traffic distribution to the SO SMOF and/or the nRT RIC SMOF.

Item [13]: The method according to item [12], wherein upon receiving the notification of completing the NF traffic distribution from the RANOAM SMOF, the nRT RIC SMOF is configured to evaluate the performance of the drained at least one NF, and based on the evaluated performance, send a report to the SO SMOF recommending whether or not to rollback the NF traffic distribution configuration, wherein upon receiving the report, the SO SMOF is configured to send a request to the ORMO to terminate a deployment of the at least one NF.

Item [14]: The method according to item [13], wherein upon receiving the request from the SO SMOF to terminate the deployment of the at least one NF, the method further includes: sending, by the ORMO, a request to the DMS to terminate the deployment of the at least one NF.

Item [15]: A method for managing interactions between an O-Cloud Resources Management and Orchestration (ORMO) Service Management Orchestration Function (SMOF) and a Radio Access Network Operations Administration Maintenance (RANOAM) function, the method including: receiving, by the ORMO, a service related to a Service Orchestration and Assurance (SOA) SMOF from a Service Management and Exposure (SME); sending, by the ORMO, a request to the SOA SMOF to drain traffic of at least one network function (NF); and sending, by the ORMO, a request to a Topology Exposure and Inventory Management (TE/IV) to update an inventory.

Item [16]: The method according to item [15], wherein upon receiving the request from the ORMO, the SOA SMOF is configured to query topology details of the at least one NF and allocated resources from the TE/IV, send a request to the ORMO to redeploy the at least one NF, and send a request to a RANOAM SMOF to distribute the traffic.

Item [17]: The method according to item [16], wherein upon receiving the request from the SOA SMOF to distribute the traffic, the RANOAM SMOF is configured to notify a non Real-Time (nRT) RIC SMOF about the request to drain traffic of the at least one NF, wherein the nRT RIC SMOF is configured to query and collect Performance Management (PM) data from a Data Management Entity (DME) and Fault Management (FM) and Configuration Management (CM) data from the RANOAM SMOF upon being notified about the request to drain traffic of the at least one NF.

Item [18]: The method according to item [17], wherein upon receiving the FM and CM data, the RANOAM SMOF is configured to send a NF traffic distribution configuration to E2 nodes, wherein the E2 nodes are configured to enforce NF traffic distribution based on the NF traffic distribution configuration to drain the at least one NF and send a notification of completing enforcing the NF traffic distribution to the RANOAM SMOF, wherein upon receiving the notification of completing the NF traffic distribution, the RANOAM SMOF is configured to forward the notification of completing the NF traffic distribution to the SOA SMOF and/or the nRT RIC SMOF.

Item [19]: The method according to item [18], wherein upon receiving the notification of completing the NF traffic distribution from the RANOAM SMOF, the nRT RIC SMOF is configured to evaluate the performance of the drained at least one NF, and based on the evaluated performance, send a report to the SOA SMOF recommending whether or not to rollback the NF traffic distribution configuration.

Item [20]. The method according to item [19], wherein upon receiving the report, the SOA SMOF is configured to send a request to the ORMO to terminate a deployment of the at least one NF.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method for managing interactions between an O-Cloud Resources Management and Orchestration (ORMO) Service Management Orchestration Function (SMOF) and a Radio Access Network Operations Administration Maintenance (RANOAM) function, the method comprising:
receiving, by the ORMO, a service related to an SMOF from a Service Management and Exposure (SME);
sending, by the ORMO, a request to the SMOF to drain traffic of at least one network function (NF); and
sending, by the ORMO, a request to a Topology Exposure and Inventory Management (TE/IV) to update an inventory.

2. The method as claimed in claim 1, wherein the SMOF is the RANOAM SMOF, and wherein upon receiving the request from the ORMO, the RANOAM SMOF is configured to notify a non Real-Time (nRT) RIC SMOF about the request to drain traffic of the at least one NF, wherein the nRT RIC SMOF is configured to query and collect Performance Management (PM) data from a Data Management Entity (DME) and Fault Management (FM) and Configuration Management (CM) data from the RANOAM SMOF upon being notified about the request to drain traffic of the at least one NF.

3. The method as claimed in claim 2, wherein upon receiving the FM and CM data, the RANOAM SMOF is configured to send a NF traffic distribution configuration to E2 nodes, wherein the E2 nodes are configured to enforce NF traffic distribution based on the NF traffic distribution configuration to drain the at least one NF and send a notification of completing enforcing the NF traffic distribution to the RANOAM SMOF.

4. The method as claimed in claim 3, wherein upon receiving the notification of completing the NF traffic distribution, the RANOAM SMOF is configured to forward the notification of completing the NF traffic distribution to the nRT RIC SMOF.

5. The method as claimed in claim 4, wherein upon receiving the notification of completing the NF traffic distribution from the RANOAM SMOF, the nRT RIC SMOF is configured to evaluate the performance of the drained at least one NF, and based on the evaluated performance, send a report to the RANOAM SMOF recommending whether or not to rollback the NF traffic distribution configuration.

6. The method as claimed in claim 5, wherein upon receiving the report, the RANOAM SMOF is configured to send a notification to the ORMO indicating traffic draining was completed.

7. The method as claimed in claim 6, wherein upon receiving the notification from the RANOAM SMOF, the method further comprises:
sending, by the ORMO, a request to a Deployment Management Service (DMS) to terminate a deployment of the at least one NF.

8. A method for managing interactions between an O-Cloud Resources Management and Orchestration (ORMO) Service Management Orchestration Function (SMOF) and a Radio Access Network Operations Administration Maintenance (RANOAM) function, the method comprising:
receiving, by the ORMO, a service related to a Service Orchestration (SO) SMOF from a Service Management and Exposure (SME);
sending, by the ORMO, a request to the SO SMOF to terminate and redeploy at least one network function (NF); and
sending, by the ORMO, a request to a Topology Exposure and Inventory Management (TE/IV) to update an inventory.

9. The method as claimed in claim 8. wherein upon receiving the request from the ORMO, the SO SMOF is configured to query topology details of the at least one NF and allocated resources from the TE/IV and send a request to the ORMO to redeploy the at least one NF.

10. The method as claimed in claim 9, wherein upon receiving the request from the SO SMOF to redeploy the at least one NF, the method further comprises:
sending, by the ORMO, a request to a Deployment Management Services (DMS) to create a new NF instance; and
sending, by the ORMO, a notification to the SO SMOF that the new NF instance was created.

11. The method as claimed in claim 10, wherein upon receiving the notification from the ORMO that the new NF instance was created, the SO SMOF is configured to send a request to a RANOAM SMOF to drain the at least one NF, wherein upon receiving the request from the SO SMOF to drain the at least one NF, the RANOAM SMOF is configured to notify a non Real-Time (nRT) RIC SMOF about the request to drain traffic of the at least one NF, wherein the nRT RIC SMOF is configured to query and collect Performance Management (PM) data from a Data Management Entity (DME) and Fault Management (FM) and Configuration Management (CM) data from the RANOAM SMOF upon being notified about the request to drain traffic of the at least one NF.

12. The method as claimed in claim 11, wherein upon receiving the FM and CM data, the RANOAM SMOF is configured to send a NF traffic distribution configuration to E2 nodes, wherein the E2 nodes are configured to enforce NF traffic distribution based on the NF traffic distribution configuration to drain the at least one NF and send a notification of completing enforcing the NF traffic distribution to the RANOAM SMOF, wherein upon receiving the notification of completing the NF traffic distribution, the RANOAM SMOF is configured to forward the notification of completing the NF traffic distribution to the SO SMOF and/or the nRT RIC SMOF.

13. The method as claimed in claim 12, wherein upon receiving the notification of completing the NF traffic distribution from the RANOAM SMOF, the nRT RIC SMOF is configured to evaluate the performance of the drained at least one NF, and based on the evaluated performance, send a report to the SO SMOF recommending whether or not to rollback the NF traffic distribution configuration, wherein upon receiving the report, the SO SMOF is configured to send a request to the ORMO to terminate a deployment of the at least one NF.

14. The method as claimed in claim 13, wherein upon receiving the request from the SO SMOF to terminate the deployment of the at least one NF, the method further comprises:
sending, by the ORMO, a request to the DMS to terminate the deployment of the at least one NF.

15. A method for managing interactions between an O-Cloud Resources Management and Orchestration (ORMO) Service Management Orchestration Function (SMOF) and a Radio Access Network Operations Administration Maintenance (RANOAM) function, the method comprising:
receiving, by the ORMO, a service related to a Service Orchestration and Assurance (SOA) SMOF from a Service Management and Exposure (SME);
sending, by the ORMO, a request to the SOA SMOF to drain traffic of at least one network function (NF); and
sending, by the ORMO, a request to a Topology Exposure and Inventory Management (TE/IV) to update an inventory.

16. The method as claimed in claim 15, wherein upon receiving the request from the ORMO, the SOA SMOF is configured to query topology details of the at least one NF and allocated resources from the TE/IV, send a request to the ORMO to redeploy the at least one NF, and send a request to a RANOAM SMOF to distribute the traffic.

17. The method as claimed in claim 16, wherein upon receiving the request from the SOA SMOF to distribute the traffic, the RANOAM SMOF is configured to notify a non Real-Time (nRT) RIC SMOF about the request to drain traffic of the at least one NF, wherein the nRT RIC SMOF is configured to query and collect Performance Management (PM) data from a Data Management Entity (DME) and Fault Management (FM) and Configuration Management (CM) data from the RANOAM SMOF upon being notified about the request to drain traffic of the at least one NF.

18. The method as claimed in claim 17, wherein upon receiving the FM and CM data, the RANOAM SMOF is configured to send a NF traffic distribution configuration to E2 nodes, wherein the E2 nodes are configured to enforce NF traffic distribution based on the NF traffic distribution configuration to drain the at least one NF and send a notification of completing enforcing the NF traffic distribution to the RANOAM SMOF, wherein upon receiving the notification of completing the NF traffic distribution, the RANOAM SMOF is configured to forward the notification of completing the NF traffic distribution to the SOA SMOF and/or the nRT RIC SMOF.

19. The method as claimed in claim 18, wherein upon receiving the notification of completing the NF traffic distribution from the RANOAM SMOF, the nRT RIC SMOF is configured to evaluate the performance of the drained at least one NF, and based on the evaluated performance, send a report to the SOA SMOF recommending whether or not to rollback the NF traffic distribution configuration.

20. The method as claimed in claim 19, wherein upon receiving the report, the SOA SMOF is configured to send a request to the ORMO to terminate a deployment of the at least one NF.
